(19) United States
(12) Patent Application Publication
(10) Pub. No.: US 2025/0374192 A1
(43) Pub. Date: Dec. 4, 2025

(54) COMMUNICATION CONTROL METHOD AND USER EQUIPMENT

(71) Applicant: KYOCERA Corporation, Kyoto (JP)

(72) Inventors: Masato FUJISHIRO, Yokohama-shi (JP); Henry CHANG, San Diego, CA (US); Hiroshi UCHIMURA, Kirishima-shi (JP); Mitsutaka HATA, Yokohama-shi (JP)

(73) Assignee: KYOCERA Corporation, Kyoto (JP)

(21) Appl. No.: 19/295,546

(22) Filed: Aug. 8, 2025

Related U.S. Application Data
(63) Continuation of application No. PCT/JP2024/004175, filed on Feb. 7, 2024.
(60) Provisional application No. 63/444,305, filed on Feb. 9, 2023.

(51) Int. Cl. H04W 52/02; H04W 76/28

(52) U.S. Cl. CPC H04W 52/0235; H04W 52/0216; H04W 76/28

(57) ABSTRACT

The present disclosure relates to a communication control method in a mobile communication system. The communication control method includes inferring, by a user equipment, occurrence or non-occurrence of data traffic in a downlink in a next DRX on-duration by using an AI/ML model. The communication control method also includes performing, by the user equipment, one of wake-up in the next DRX on-duration or skipping of the wake-up in the next DRX on-duration, based on an inference result for occurrence or non-occurrence of the data traffic.

### RELATED APPLICATIONS

The present application is a continuation based on PCT Application No. PCT/JP2024/004175, filed on Feb. 7, 2024, which claims the benefit of U.S. Provisional Application No. 63/444,305 filed on Feb. 9, 2023. The content of which is incorporated by reference herein in their entirety.

### TECHNICAL FIELD

The present disclosure relates to a communication control method and user equipment.

### BACKGROUND

In recent years, in the Third Generation Partnership Project (3GPP) (trade name), which is a standardization project for mobile communication systems, a study is underway to apply an Artificial Intelligence (AI) technology, particularly, a Machine Learning (ML) technology to wireless communication (air interface) in the mobile communication system.

For example, Non-Patent Document 1 listed below states that when an AI algorithm was applied to DRX (Discontinuous Reception) and a simulation for predicting a next traffic burst was performed, a delay (latency) was successfully significantly reduced with power consumption similar to that of a conventional DRX configuration. Non-Patent Document 2 listed below discusses identifying a high-layer use case to which AI/ML is applied, such as dynamic TDD, positioning, mobility management, or service awareness RRM, and studying performance evaluation for the use case.

### CITATION LIST

### Non-Patent Literature

Non-Patent Document 1: 3GPP contribution document: RP-223079, “Study on AI/ML for NR air interface higher layer”
Non-Patent Document 2: 3GPP contribution document: RP-222954, “Motivation on AI/ML for NR air interface high layer”

### SUMMARY

In an aspect, a communication control method is a communication control method in a mobile communication system. The communication control method includes inferring, by a user equipment, occurrence or non-occurrence of data traffic in a downlink in a next DRX on-duration by using an AI/ML model. The communication control method also includes performing, by the user equipment, one of wake-up in the next DRX on-duration or skipping of the wake-up in the next DRX on-duration, based on an inference result for occurrence or non-occurrence of the data traffic.

In an aspect, a communication control method is a communication control method in a mobile communication system. The communication control method includes inferring, by a network node, occurrence or non-occurrence of data traffic in a downlink in a next DRX on-duration by using an AI/ML model. The communication control method also includes transmitting, to a user equipment by the network node, a first dynamic DRX indication indicating one of wake-up in the next DRX on-duration or sleep in the next DRX on-duration based on an inference result for occurrence or non-occurrence of the data traffic. The communication control method further includes inferring, by the user equipment, occurrence or non-occurrence of the data traffic in the next DRX on-duration by using the AI/ML model. The communication control method further includes, performing, by the user equipment, the wake-up at a timing corresponding to wake-up indicated by both the first dynamic DRX indication and the inference result from the user equipment, based on the first dynamic DRX indication and the inference result from the user equipment.

### BRIEF DESCRIPTION OF THE DRAWINGS

FIG. 1 is a diagram illustrating a configuration example of a mobile communication system according to a first embodiment.

FIG. 2 is a diagram illustrating a configuration example of a user equipment (UE) according to the first embodiment.

FIG. 3 is a diagram illustrating a configuration example of a base station (gNB) according to the first embodiment.

FIG. 4 is a diagram illustrating a configuration example of a protocol stack according to the first embodiment.

FIG. 5 is a diagram illustrating a configuration example of a protocol stack according to the first embodiment.

FIG. 6 is a diagram illustrating a configuration example of functional blocks of an AI/ML technology according to the first embodiment.

FIG. 7 is a diagram illustrating an operation example in an AI/ML technology according to the first embodiment.

FIG. 8 is a diagram illustrating an arrangement example of functional blocks of the AI/ML technology according to the first embodiment.

FIG. 9 is a diagram illustrating an example of reducing CSI-RSs according to the first embodiment.

FIG. 10 is a diagram illustrating an example of reducing the CSI-RSs according to the first embodiment.

FIG. 11 is a diagram illustrating an example of an operation according to the first embodiment.

FIG. 12 is a diagram illustrating an arrangement example of functional blocks of the AI/ML technology according to the first embodiment.

FIG. 13 is a diagram illustrating an arrangement example of functional blocks of the AI/ML technology according to the first embodiment.

FIG. 14 is a diagram illustrating an arrangement example of functional blocks of the AI/ML technology according to the first embodiment.

FIG. 15 is a diagram illustrating an operation example according to the first embodiment.

FIG. 16 is a diagram illustrating an arrangement example of functional blocks of the AI/ML technology according to the first embodiment.

FIG. 17 is a diagram illustrating an operation example according to the first embodiment.

FIG. 18 is a diagram illustrating an operation example according to the first embodiment.

FIG. 19 is a diagram illustrating an example of a configuration message according to the first embodiment.

FIGS. 20A and 20B illustrate an example of a DRX cycle according to the first embodiment, and FIG. 20C is a diagram illustrating a flow of wake-up decisions according to the first embodiment.

FIG. 21 is a diagram illustrating a first operation example according to the first embodiment.

FIG. 22 is a diagram illustrating a second operation example according to the first embodiment.

FIGS. 23A and 23B are diagrams illustrating timing examples according to the first embodiment.

FIG. 24 is a diagram illustrating a first operation example according to a second embodiment.

FIGS. 25A to 25C are diagrams illustrating a timing example according to the second embodiment.

FIG. 26 is a diagram illustrating a second operation example according to the second embodiment.

FIG. 27 is a diagram illustrating an operation example of a control period scheme according to a second embodiment.

FIGS. 28A to 28C are diagrams illustrating timing examples according to the second embodiment.

FIG. 29 is a diagram illustrating a third operation example according to the second embodiment.

FIGS. 30A to 30C are diagrams illustrating timing examples according to the second embodiment.

FIG. 31 illustrates a first operation example according to a third embodiment.

FIGS. 32A to 32D are diagrams illustrating timing examples according to the third embodiment.

FIG. 33 is a diagram illustrating a second operation example according to the third embodiment.

FIGS. 34A to 34D are diagrams illustrating timing examples according to the third embodiment.

### DESCRIPTION OF EMBODIMENTS

### First Embodiment

A mobile communication system according to a first embodiment will be described with reference to the drawings. In the description of the drawings, the same or similar parts are denoted by the same or similar reference signs.

### Configuration of Mobile Communication System

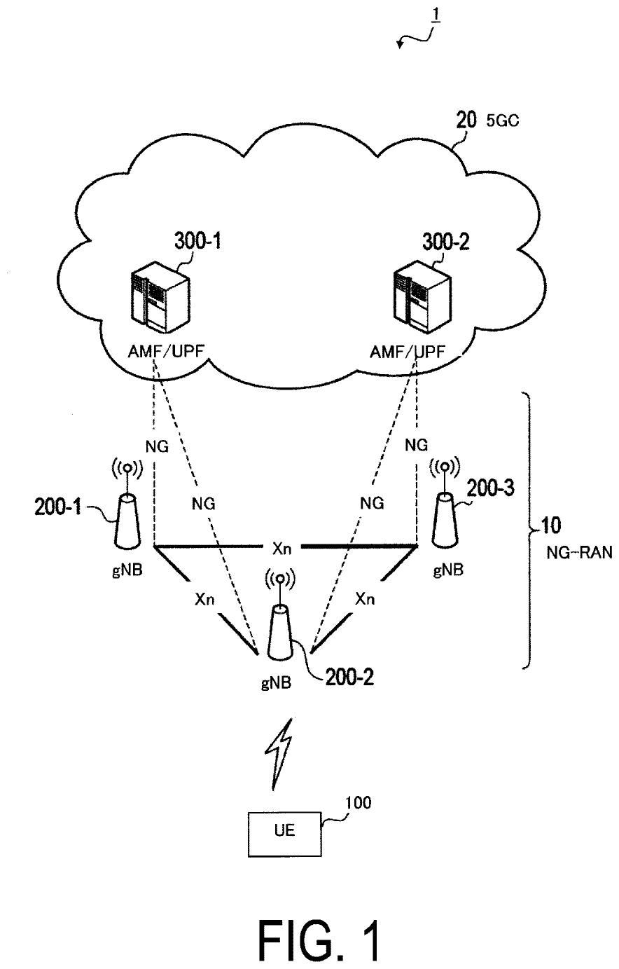

A configuration of a mobile communication system according to a first embodiment will be described. FIG. 1 is a diagram illustrating a configuration example of the mobile communication system 1 according to the first embodiment. The mobile communication system 1 complies with the 5th Generation System (5GS) of the 3GPP standard. 5GS will be hereinafter used as an example, but a Long Term Evolution (LTE) system may be applied at least partially to the mobile communication system. A system of the sixth (6G) or subsequent generation system may be at least partially applied to the mobile communication system.

The mobile communication system 1 includes User Equipment (UE) 100, a 5G radio access network (Next Generation Radio Access Network (NG-RAN)) 10, and a 5G Core Network (5GC) 20. The NG-RAN 10 will be hereinafter simply referred to as the RAN 10. The 5GC 20 may be simply referred to as the core network (CN) 20.

The UE 100 is a mobile wireless communication apparatus. The UE 100 may be any apparatus as long as the UE 100 is used by a user. Examples of the UE 100 include a mobile phone terminal (including a smartphone) and/or a tablet terminal, a notebook PC, a communication module (including a communication card or a chipset), a sensor or an apparatus provided on a sensor, a vehicle or an apparatus provided on a vehicle (Vehicle UE), and a flying object or an apparatus provided on a flying object (Aerial UE).

The NG-RAN 10 includes base stations (referred to as “gNBs” in the 5G system) 200. The gNBs 200 are interconnected via an Xn interface which is an inter-base station interface. Each gNB 200 manages one or more cells. The gNB 200 performs wireless communication with the UE 100 that has established a connection to the cell of the gNB 200. The gNB 200 has a radio resource management (RRM) function, a function of routing user data (hereinafter simply referred to as “data”), a measurement control function for mobility control and scheduling, and the like. The “cell” is used as a term representing a minimum unit of a wireless communication area. The “cell” is also used as a term representing a function or a resource for performing wireless communication with the UE 100. One cell belongs to one carrier frequency (hereinafter simply referred to as a “frequency”).

Note that the gNB can be connected to an Evolved Packet Core (EPC) corresponding to a core network of LTE. An LTE base station can also be connected to the 5GC. The LTE base station and the gNB can be connected via an inter-base station interface.

The 5GC 20 includes an Access and Mobility Management Function (AMF) and a User Plane Function (UPF) 300. The AMF performs various types of mobility controls and the like for the UE 100. The AMF manages mobility of the UE 100 by communicating with the UE 100 by using Non-Access Stratum (NAS) signaling. The UPF controls data transfer. The AMF and UPF 300 are connected to the gNB 200 via an NG interface which is an interface between a base station and the core network. The AMF and the UPF 300 may be core network apparatuses included in the CN 20.

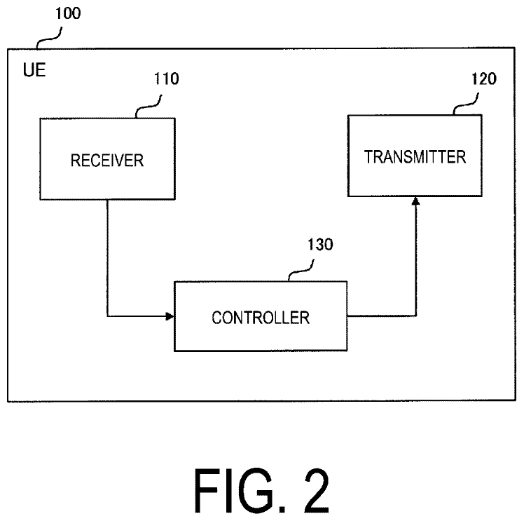

FIG. 2 is a diagram illustrating a configuration example of the UE 100 (user equipment) according to the first embodiment. The UE 100 includes a receiver 110, a transmitter 120, and a controller 130. The receiver 110 and the transmitter 120 constitute a communicator that performs wireless communication with the gNB 200. The UE 100 is an example of the communication apparatus.

The receiver 110 performs various types of reception under control of the controller 130. The receiver 110 includes an antenna and a reception device. The reception device converts a radio signal received through the antenna into a baseband signal (a reception signal) and outputs the resulting signal to the controller 130.

The transmitter 120 performs various types of transmission under control of the controller 130. The transmitter 120 includes an antenna and a transmission device. The transmission device converts a baseband signal (a transmission signal) output by the controller 130 into a radio signal and transmits the resulting signal through the antenna.

The controller 130 performs various types of control and processing in the UE 100. Such processing includes processing of respective layers to be described later. The controller 130 includes at least one processor and at least one memory. The memory stores a program to be executed by the processor and information to be used for processing by the processor. The processor may include a baseband processor and a Central Processing Unit (CPU). The baseband processor performs modulation and demodulation, coding and decoding, and the like of a baseband signal. The CPU executes the program stored in the memory to thereby perform various types of processing. Note that processing or operations performed in the UE 100 may be performed in the controller 130.

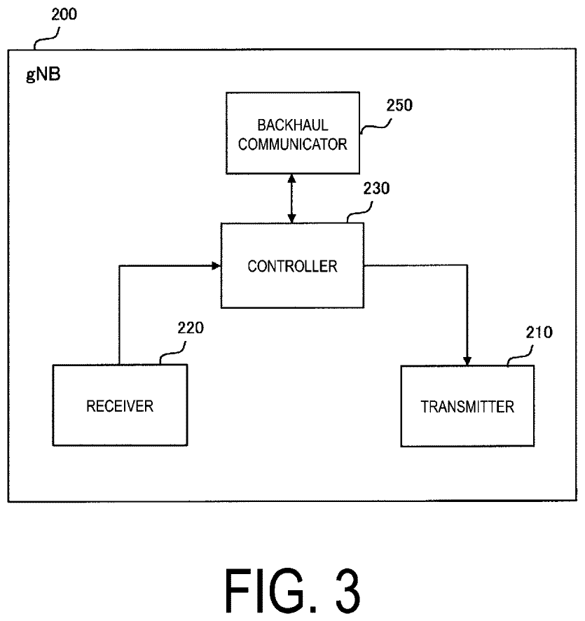

FIG. 3 is a diagram illustrating an example of a configuration of the gNB 200 (base station) according to the first embodiment. The gNB 200 includes a transmitter 210, a receiver 220, a controller 230, and a backhaul communicator 250. The transmitter 210 and the receiver 220 constitute a communicator that performs wireless communication with the UE 100. The backhaul communicator 250 constitutes a network communicator that communicates with the CN 20. The gNB 200 is another example of the communication apparatus.

The transmitter 210 performs various types of transmission under control of the controller 230. The transmitter 210 includes an antenna and a transmission device. The transmission device converts a baseband signal (a transmission signal) output by the controller 230 into a radio signal and transmits the resulting signal through the antenna.

The receiver 220 performs various types of reception under control of the controller 230. The receiver 220 includes an antenna and a reception device. The reception device converts a radio signal received through the antenna into a baseband signal (a reception signal) and outputs the resulting signal to the controller 230.

The controller 230 performs various types of control and processing in the gNB 200. Such processing includes processing of respective layers to be described later. The controller 230 includes at least one processor and at least one memory. The memory stores a program to be executed by the processor and information to be used for processing by the processor. The processor may include a baseband processor and a CPU. The baseband processor performs modulation and demodulation, coding and decoding, and the like of a baseband signal. The CPU executes the program stored in the memory to thereby perform various types of processing. In an example described below, operations or processing performed in the gNB 200 may be performed by the controller 230.

The backhaul communicator 250 is connected to a neighboring base station via an Xn interface which is an inter-base station interface. The backhaul communicator 250 is connected to the AMF/UPF 300 via an NG interface being an interface between a base station and the core network. Note that the gNB 200 may include a central unit (CU) and a distributed unit (DU) (i.e., functions are divided), and the two units may be connected via an F1 interface, which is a fronthaul interface.

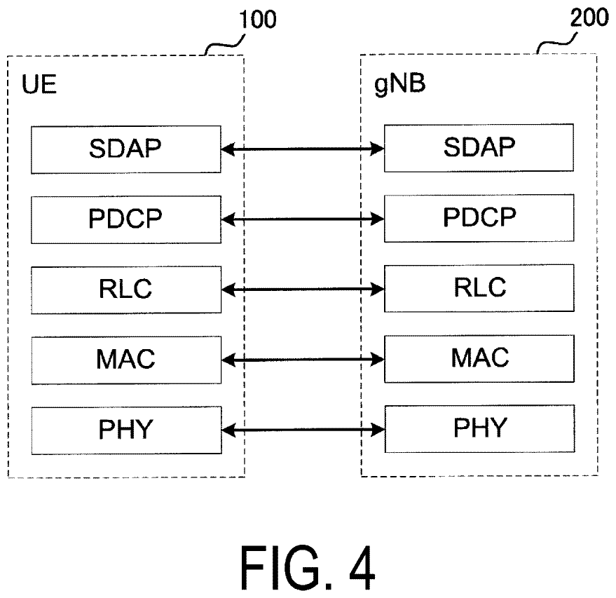

FIG. 4 is a diagram illustrating an example of a configuration of a protocol stack of a user plane radio interface that handles data.

The user plane radio interface protocol includes a physical (PHY) layer, a medium access control (MAC) layer, a radio link control (RLC) layer, a packet data convergence protocol (PDCP) layer, and a service data adaptation protocol (SDAP) layer.

The PHY layer performs coding and decoding, modulation and demodulation, antenna mapping and demapping, and resource mapping and demapping. Data and control information are transmitted between the PHY layer of the UE 100 and the PHY layer of the gNB 200 via a physical channel. Note that the PHY layer of the UE 100 receives downlink control information (DCI) transmitted from the gNB 200 over a physical downlink control channel (PDCCH). Specifically, the UE 100 blind decodes the PDCCH using a radio network temporary identifier (RNTI) and acquires successfully decoded DCI as DCI addressed to the UE 100. A Cyclic Redundancy Code (CRC) parity bit scrambled by the RNTI is added to the DCI transmitted from the gNB 200.

In NR, the UE 100 can use a bandwidth narrower than a system bandwidth (i.e., a cell bandwidth). The gNB 200 configures a bandwidth part (BWP) consisting of consecutive Physical Resource Blocks (PRBs) for the UE 100. The UE 100 transmits and receives data and control signals in an active BWP. For example, up to four BWPs may be configurable for the UE 100. Each BWP may have a different subcarrier spacing. Frequencies of the BWPs may overlap with each other. When a plurality of BWPs are configured for the UE 100, the gNB 200 can designate which BWP to apply by controlling the downlink. By doing so, the gNB 200 dynamically adjusts the UE bandwidth according to an amount of data traffic in the UE 100 or the like to reduce the UE power consumption.

The gNB 200 can configure, for example, up to three control resource sets (CORESETs) for each of up to four BWPs on a serving cell. The CORESET is a radio resource for control information to be received by the UE 100. Up to 12 or more CORESETs may be configured for the UE 100 on the serving cell. Each CORESET may have an index of 0 to 11 or more. A CORESET may include 6 resource blocks (PRBs) and one, two or three consecutive Orthogonal Frequency Division Multiplex (OFDM) symbols in the time domain.

The MAC layer performs priority control of data, retransmission processing through Hybrid Automatic Repeat reQuest (HARQ: Hybrid ARQ), a random access procedure, and the like. Data and control information are transmitted between the MAC layer of the UE 100 and the MAC layer of the gNB 200 via a transport channel. The MAC layer of the gNB 200 includes a scheduler. The scheduler decides transport formats (transport block sizes, Modulation and Coding Schemes (MCSs)) in the uplink and the downlink and resource blocks to be allocated to the UE 100.

The RLC layer transmits data to the RLC layer on the reception end by using functions of the MAC layer and the PHY layer. Data and control information are transmitted between the RLC layer of the UE 100 and the RLC layer of the gNB 200 via a logical channel.

The PDCP layer performs header compression/decompression, encryption/decryption, and the like.

The SDAP layer performs mapping between IP flows, which are units for Quality of Service (QOS) control by the core network, and radio bearers, which are units for QoS control by the Access Stratum (AS). Note that, when the RAN is connected to the EPC, the SDAP need not be provided.

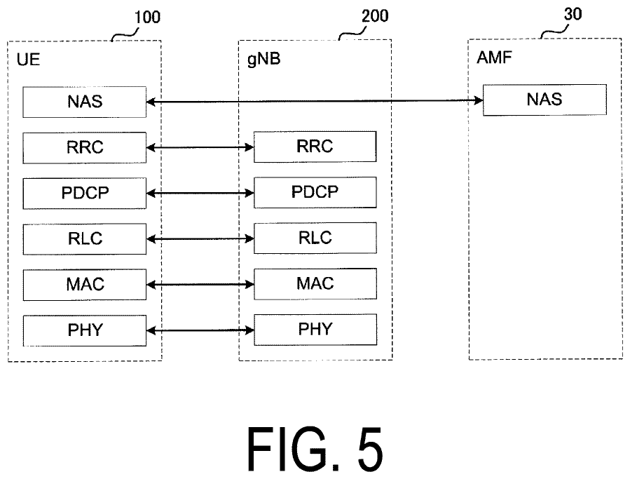

FIG. 5 is a diagram illustrating a configuration of a protocol stack of a radio interface of a control plane handling signaling (a control signal).

The protocol stack of the radio interface of the control plane includes a radio resource control (RRC) layer and a Non-Access Stratum (NAS) instead of the SDAP layer illustrated in FIG. 4.

RRC signaling for various configurations is transmitted between the RRC layer of the UE 100 and the RRC layer of the gNB 200. The RRC layer controls a logical channel, a transport channel, and a physical channel according to establishment, re-establishment, and release of a radio bearer. When a connection (RRC connection) between the RRC of the UE 100 and the RRC of the gNB 200 is present, the UE 100 is in an RRC connected state. When no connection (RRC connection) between the RRC of the UE 100 and the RRC of the gNB 200 is present, the UE 100 is in an RRC idle state. When the connection between the RRC of the UE 100 and the RRC of the gNB 200 is suspended, the UE 100 is in an RRC inactive state.

The NAS, which is located above the RRC layer, performs session management, mobility management, and the like. NAS signaling is transmitted between the NAS of the UE 100 and the NAS of the AMF 300. Note that the UE 100 includes an application layer other than the protocol of the radio interface. A layer lower than the NAS is referred to as an Access Stratum (AS).

### AI/ML Technology

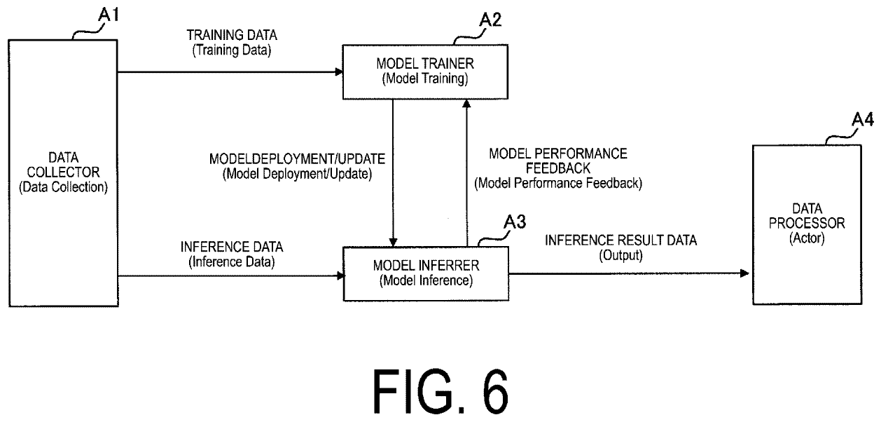

In the embodiment, an AI/ML Technology will be described. FIG. 6 is a diagram illustrating a configuration example of functional blocks of the AI/ML technology in the mobile communication system 1 according to the first embodiment.

The functional block configuration example illustrated in FIG. 6 includes a data collector A1, a model trainer A2, a model inferrer A3, and a data processor A4.

The data collector A1 collects input data, specifically, training data and inference data. The data collector A1 outputs the training data to the model trainer A2. The data collector A1 also outputs the inference data to the model inferrer A3. The data collector A1 may acquire data in the apparatus in which the data collector A1 is provided, as input data. The data collector A1 may acquire, as the input data, data in another apparatus.

The model trainer A2 performs model training. Specifically, the model trainer A2 optimizes parameters of the training model through machine learning using the training data, and derives (or deploys, or updates) the trained model. The model trainer A2 outputs the derived trained model to the model inferrer A3. For example, considering y=ax+b, a (slope) and b (intercept) are the parameters, and optimizing these parameters corresponds to the machine learning. In general, machine learning includes supervised learning, unsupervised learning, and reinforcement learning. Supervised learning is a method of using correct answer data for the training data. Unsupervised learning is a method of not using correct answer data for the training data. For example, in unsupervised learning, feature points are learned from a large amount of training data, and correct answer determination (range estimation) is performed. The reinforcement learning is a method of assigning a score to an output result and learning a method of maximizing the score. Although supervised learning will be described below, unsupervised learning or reinforcement learning may be applied as machine learning.

The model inferrer A3 performs model inference. To be specific, the model inferrer A3 infers an output from the inference data by using the trained model, and outputs inference result data to the data processor A4. For example, considering y=ax+b, x is the inference data and y corresponds to the inference result data. Note that “y=ax+b” is a model. A model in which a slope and an intercept are optimized, for example, “y=5x+3” is a trained model. The model has various approaches, such as linear regression analysis, neural network, and decision tree analysis. The above “y=ax+b” can be considered as a kind of the linear regression analysis. The model inferrer A3 may perform model performance feedback to the model trainer A2.

The data processor A4 receives the inference result data and performs processing that utilizes the inference result data.

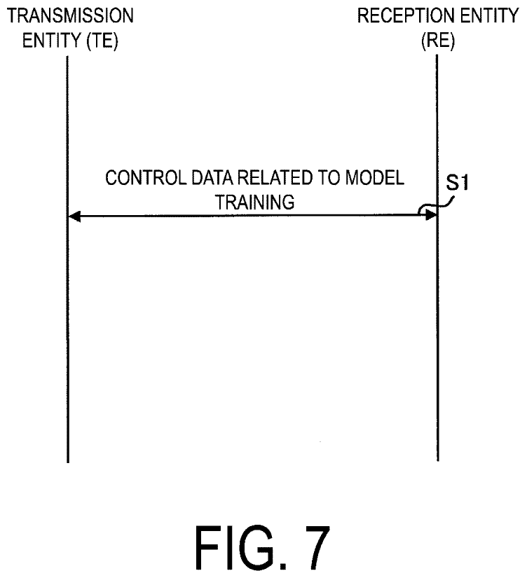

FIG. 7 is a diagram illustrating an operation example in the AI/ML technology according to the first embodiment.

A transmission entity TE is, for example, an entity in which machine learning is performed. The transmission entity TE derives a trained model by performing machine learning. Then, the transmission entity TE uses the trained model to generate inference result data as an inference result. The transmission entity TE transmits the inference result data to a reception entity RE.

The reception entity RE is, for example, an entity in which no machine learning is performed. The transmission entity TE performs various processing operations by using the inference result data received from the transmission entity TE.

Note that the entity may be, for example, a device. The entity may be a functional block included in the device. The entity may be, for example, a hardware block included in the device.

For example, the transmission entity TE may be the UE 100, and the reception entity RE may be the gNB 200 or a core network apparatus. Alternatively, the transmission entity TE may be the gNB 200 or a core network apparatus, and the reception entity RE may be the UE 100.

As illustrated in FIG. 7, in a step S1, the transmission entity TE transmits to and receives from the reception entity RE control data related to the AI/ML technique. The control data may be an RRC message that is RRC layer (i.e., layer 3) signaling. The control data may be a MAC Control Element (CE) that is MAC layer (i.e., layer 2) signaling. The control data may be Downlink Control Information (DCI) that is PHY layer (i.e., layer 1) signaling. The downlink signaling may be UE-specific signaling. The downlink signaling may be broadcast signaling. The control data may be a control message in a control layer (e.g., an AI/ML layer) dedicated to artificial intelligence or machine learning.

### Arrangement Examples and Use Cases

How the functional blocks illustrated in FIG. 6 are arranged in the mobile communication system 1 will be described. Hereinafter, arrangement examples of the functional blocks will be described along specific use cases.

Use cases applied in the AI/ML technology include, for example, the following three cases.
(1.1) “Channel State Information (CSI) feedback enhancement”
(1.2) “Beam management”
(1.3) “Positioning accuracy enhancement”

Hereinafter, an arrangement example of the functional blocks will be described for each use case.

### (1.1) Arrangement Example of Functional Blocks in “CSI Feedback Enhancement”

The “CSI feedback enhancement” represents, for example, a use case where the machine learning technology is applied to the CSI fed back from the UE 100 to the gNB 200. The CSI is information related to a downlink channel state between the UE 100 and the gNB 200. The CSI includes at least one selected from the group consisting of a Channel Quality Indicator (CQI), a Precoding Matrix Indicator (PMI), and a Rank Indicator (RI). The gNB 200 performs, for example, downlink scheduling based on the CSI feedback from the UE 100.

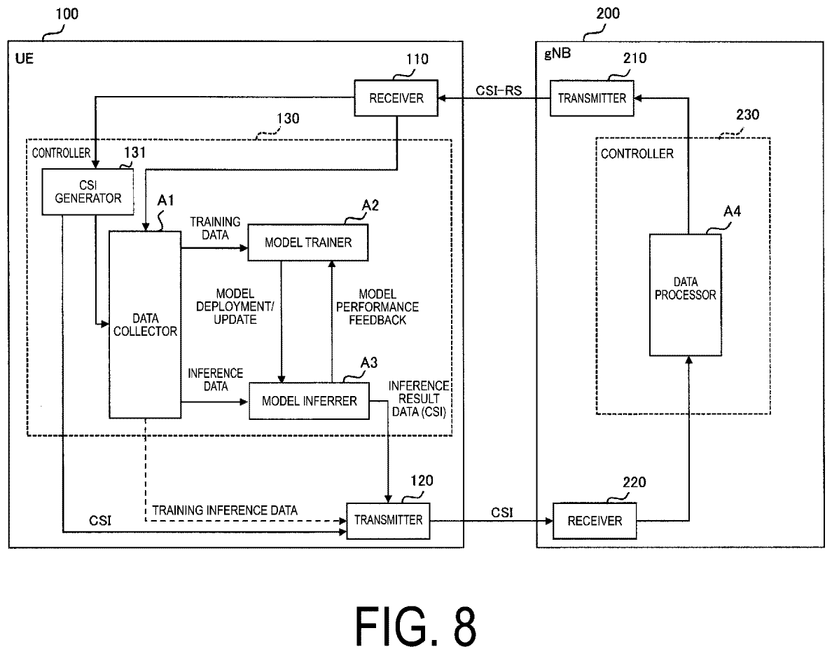

FIG. 8 is a diagram illustrating an arrangement example of the functional blocks in the “CSI feedback enhancement”. In the example of “CSI feedback enhancement” illustrated in FIG. 8, the controller 130 of the UE 100 includes the data collector A1, the model trainer A2, and the model inferrer A3. On the other hand, the controller 230 of the gNB 200 includes the data processor A4. In other words, the UE 100 performs model training and model inference. FIG. 8 illustrates an example in which the transmission entity TE is the UE 100 and the reception entity RE is the gNB 200.

In the “CSI feedback enhancement”, the gNB 200 transmits a reference signal for the UE 100 to estimate the downlink channel state. The reference signal will be described below taking a CSI reference signal (CSI-RS) as an example, but may be a demodulation reference signal (DMRS).

First, in the model training, the UE 100 (receiver 110) receives a first reference signal from the gNB 200 by using first resources. Then, the UE 100 (model trainer A2) derives a trained model for inferring CSI from the reference signal by using training data including the first reference signal. Such a first reference signal may be referred to as a full CSI-RS.

For example, the CSI generator 131 performs channel estimation by using the reception signal (CSI-RS) received by the receiver 110, and generates CSI. The transmitter 120 transmits the generated CSI to the gNB 200. The model trainer A2 performs model training by using a set of the reception signal (CSI-RS) and the CSI as the training data to derive a trained model for inferring the CSI from the reception signal (CSI-RS).

Second, in the model inference, the receiver 110 receives a second reference signal from the gNB 200 by using second resources the amount of which is smaller than that of the first resources. Then, the model inferrer A3 uses the trained model to infer the CSI as inference result data using the second reference signal as inference data. Such a second reference signal may hereinafter be referred to as a partial CSI-RS or a punctured CSI-RS.

For example, the model inferrer A3 causes the partial CSI-RS received by the receiver 110 to be input to the trained model as the inference data, and infers the CSI from the CSI-RS. The transmitter 120 transmits the inferred CSI to the gNB 200.

This enables the UE 100 to feed back (or transmit), to the gNB 200, accurate (complete) CSI from the fewer CSI-RSs (partial CSI-RS) received from the gNB 200. For example, the gNB 200 can reduce (puncture) the CSI-RS when intended for overhead reduction. The UE 100 can cope with a situation in which a radio situation deteriorates and some CSI-RSs cannot be normally received.

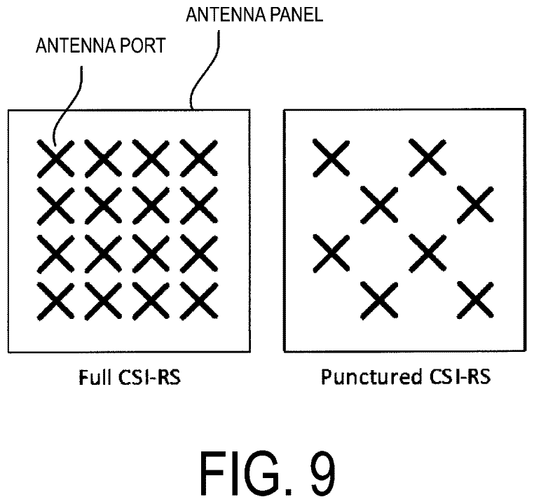

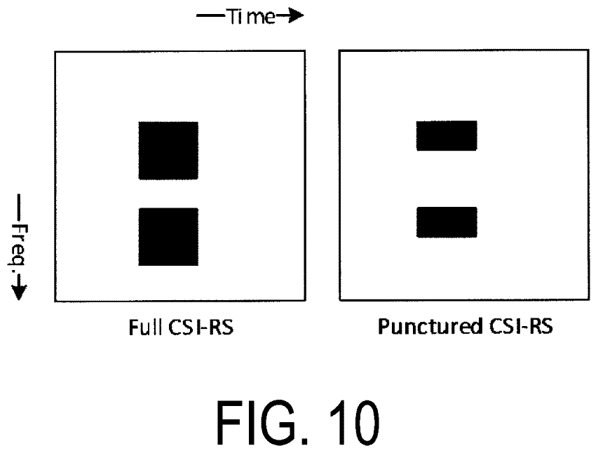

FIGS. 9 and 10 are diagrams illustrating an example of reducing CSI-RSs according to the first embodiment.

FIG. 9 illustrates an example in which the CSI-RSs are reduced by reducing the number of antenna ports for transmitting the CSI-RSs. For example, the gNB 200 may perform the following processing. In other words, the gNB 200 transmits the CSI-RS from all antenna ports of the antenna panel in a mode in which the UE 100 performs the model training (which may hereinafter be referred to as a “training mode”). On the other hand, in the mode in which the UE 100 performs model inference (which may hereinafter be referred to as an “inference mode”), the gNB 200 reduces the number of antenna ports for transmitting the CSI-RS, and transmits the CSI-RS from half the antenna ports of the antenna panel. This enables reduced overhead and improved utilization efficiency for the antenna ports, and allows a reduction effect for power consumption to be produced. Note that the antenna port is an example of the resource.

On the other hand, FIG. 10 illustrates an example in which the gNB 200 reduces the number of radio resources used to transmit the CSI-RS, specifically, the number of time-frequency resources. For example, the gNB 200 may perform the following processing. In other words, when the UE 100 is in the training mode, the gNB 200 transmits the CSI-RS by using predetermined time-frequency resources. On the other hand, when the UE 100 is in the inference mode, the gNB 200 transmits the CSI-RS using time-frequency resources the amount of which is smaller than that of the predetermined time-frequency resources. This enables reduced overhead and improved utilization efficiency for the radio resources, and allows a reduction effect for power consumption to be produced.

As illustrated in FIGS. 9 and 10, the gNB 200 transmits the full CSI-RS using a predetermined amount of first resources, and transmits the partial CSI-RS using second resources that are less than the first resources.

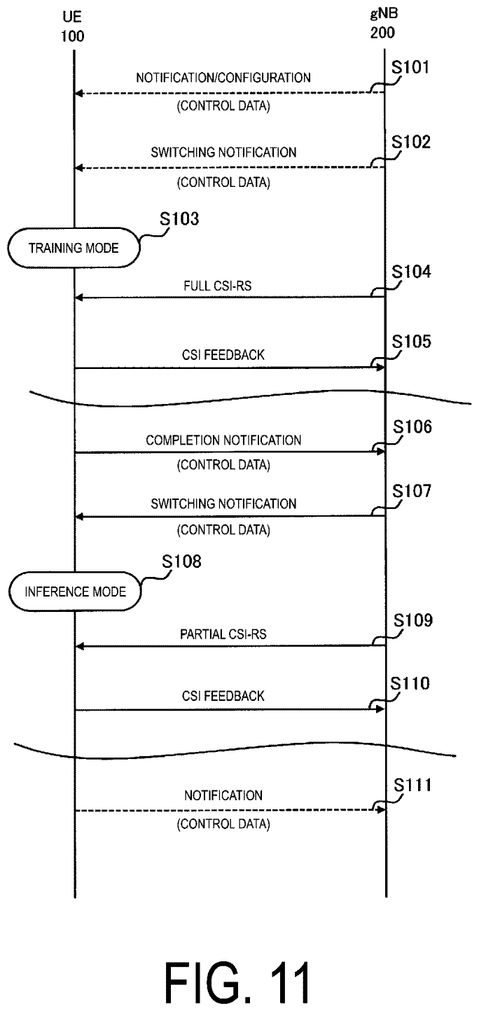

FIG. 11 illustrates an operation example in the “CSI feedback enhancement” according to the first embodiment.

As illustrated in FIG. 11, in step S101, the gNB 200 may notify the UE 100 of or configure for the UE, as the control data, a transmission pattern (punctured pattern) of the CSI-RS in the inference mode. For example, the gNB 200 transmits, to the UE 100, antenna ports and/or time-frequency resources used or not used to transmit the CSI-RS in the inference mode.

In step S102, the gNB 200 may transmit, to the UE 100, a switching notification for causing the UE 100 to start the training mode.

In step S103, the UE 100 starts the training mode.

In step S104, the gNB 200 transmits a full CSI-RS. The receiver 110 of the UE 100 receives the full CSI-RS, and the CSI generator 131 generates (estimates) CSI based on the full CSI-RS. In the training mode, the data collector A1 collects the full CSI-RS and the CSI. The model trainer A2 uses the full CSI-RS and the CSI as training data to generate a trained model.

In step S105, the UE 100 transmits the generated CSI to the gNB 200.

Thereafter, in step S106, when the model training is completed, the UE 100 transmits, to the gNB 200, a completion notification indicating that the model training is completed. The UE 100 may transmit the completion notification when creation of the trained model is completed.

In step S107, in response to receiving the completion notification, the gNB 200 transmits, to the UE 100, a switching information notification for switching from the training mode to the inference mode.

In step S108, in response to receiving the switching notification, the UE 100 switches from the training mode to the inference mode.

In step S109, the gNB 200 transmits a partial CSI-RS. The receiver 110 of the UE 100 receives the partial CSI-RS. In the inference mode, the data collector A1 collects the partial CSI-RS. The model inferrer A3 causes the partial CSI-RS to be input to the trained model as inference data, and obtains CSI as an inference result.

In step S110, the UE 100 transmits (or feeds back) the CSI, which is an inference result, to the gNB 200 as inference result data. The UE 100 can deploy a trained model with a predetermined accuracy or higher by repeating model training in the training mode. The inference result obtained by using the trained model deployed as described above is expected to have a predetermined accuracy or higher.

Note that, in step S111, upon determining that the model training is necessary, the UE 100 may transmit a notification as the control data to the gNB 200, the notification indicating that the model training is necessary.

In the description of the example illustrated in FIG. 11, the training data is “(full) CSI-RS” and “CSI”, and the inference data is “(partial) CSI-RS”. Hereinafter, the training data and/or the inference data may be referred to as a “dataset”.

In the “CSI feedback enhancement”, for example, at least one selected from the group consisting of the following data and/or information may be used as the dataset in addition to the “CSI-RS” and the “CSI”.

(X1) Reference Signals Received Power (RSRP), Reference Signal Received Quality (RSRQ), Signal-to-interference-plus-noise ratio (SINR), or an output waveform of an AD converter (a measurement target of these data may be the CSI-RS. The measurement target may be other reception signals received from the gNB 200)

(X2) Bit Error Rate (BER) or Block Error Rate (BLER) ((BER (or BLER) may be measured based on CSI-RS with a total number of transmission bits (or a total number of transmission blocks) being known)

(X3) Moving speed of the UE 100 (which may be measured by a speed sensor in the UE 100)

What is used as a dataset used for machine learning may be configured. For example, the following processing may be performed. In other words, the UE 100 transmits capability information as the control data to the gNB 200, the capability information indicating which type of input data the UE 100 can handle in the machine learning. The capability information may represent, for example, any of the data or information indicated in (X1) to (X3). The capability information may be information in which training data and inference data are separately designated. The gNB 200 transmits the data type information used as a dataset, to the UE 100 as the control data. The data type information may represent, for example, any one of data or information indicated in (X1) to (X3). As the data type information, data type information used as training data and data type information used as inference data may be separately designated.

### (1.2) Arrangement Example of Functional Blocks in “Beam Management”

An arrangement example of the functional blocks in the “beam management” will be described. The “beam management” represents, for example, a use case where the machine learning technology is used to manage which beam is an optimum beam among the beams transmitted from the gNB 200.

In the “beam management”, the gNB 200 sequentially transmits beams having different directivities. Each beam includes, for example, a reference signal. The UE 100 measures the reception quality of each beam using the reference signal included in the beam. The UE 100 determines, for example, a beam with the best reception quality as the optimum beam.

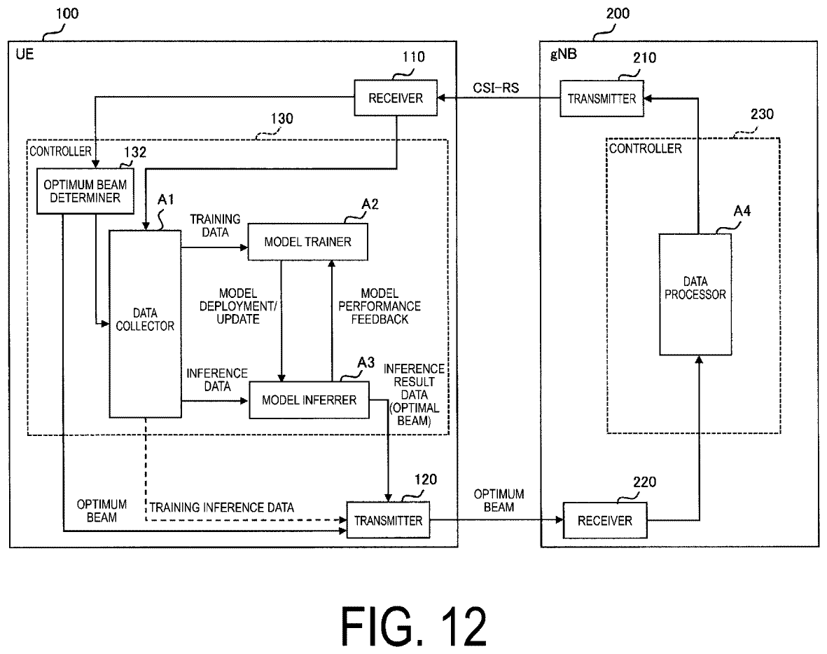

FIG. 12 is a diagram illustrating an arrangement example of the functional blocks in the “beam management”. In the example of the “beam management” illustrated in FIG. 12, the controller 130 of the UE 100 includes the data collector A1, the model trainer A2, and the model inferrer A3. On the other hand, the controller 230 of the gNB 200 includes the data processor A4. In other words, FIG. 12 illustrates an example in which the UE 100 perform model training and model inference. FIG. 12 illustrates the example in which the transmission entity TE is the UE 100 and the reception entity RE is the gNB 200.

As illustrated in FIG. 12, the UE 100 includes an optimum beam determiner 132. The optimum beam determiner 132 determines the optimum beam based on, for example, the reception quality of the reference signal included in each beam. As with “CSI feedback”, an example in which a CSI-RS is used as the reference signal will be described, but a demodulation reference signal (DMRS) may be used as the reference signal. The transmitter 120 transmits information representing the determined optimum beam to the gNB 200 as the “optimum beam”.

An operation example in the “beam management” can be implemented by replacing the “CSI feedback” with the “optimum beam” in FIG. 11.

In the training mode (step S103), the gNB 200 sequentially transmits, to the UE 100, beams having different directivities (step S104). Each beam includes the full CSI-RS. In the training mode, the data collector A1 of the UE 100 collects the full CSI-RS and the optimum beam (information indicating the optimum beam). The model trainer A2 generates a trained model using the CSI-RS and the optimum beam (information indicating the optimum beam) as training data. The full CSI-RS is an example of the first reference signal, and the partial CSI-RS is an example of the second reference signal.

In the inference mode (step S108), the gNB 200 sequentially transmits beams having different directivities. Each beam includes a partial CSI-RS. In the inference mode, the data collector A1 collects the partial CSI-RS. The model inferrer A3 causes the partial CSI-RS to be input to the trained model as inference data, and obtains the optimum beam (information indicating the optimum beam) as an inference result. The UE 100 transmits the inference result (optimum beam) to the gNB 200 as inference result data.

In the “beam management”, in addition to the “CSI-RS” and the “optimum beam”, for example, at least one selected from the group consisting of the following data or information may be used as the data used for the dataset.

(Y1) Synchronization Signal Block (SSB) received from the gNB 200

(Y2) RSRP, RSRQ, SINR, or the output waveform of the AD converter (a measurement target thereof may be the CSI-RS. The measurement target may be other reception signals received from the gNB 200)

(Y3) BER or BLER ((BER (or BLER) may be measured based on the CSI-RS with the total number of transmission bits (or the total number of transmission blocks) known)

(Y4) Number of beams or a beam pattern

(Y5) Measurement value of a beam (including multiple values)

(Y6) Moving speed of the UE 100 (which may be measured by the speed sensor in the UE 100)

The UE 100 may transmit capability information as the control data to the gNB 200, the capability information indicating which type of input data the UE 100 can handle in the machine learning. The capability information may include any information or data from among (Y1) to (Y6). Aside from the training data and the inference data, the capability information may include any information or data from among (Y1) to (Y6). The gNB 200 may transmit the data type information used as a dataset, to the UE 100 as the control data. The data type information may include, for example, any of the data or information indicated in (Y1) to (Y6). Aside from the training data and the inference data, the data type information may include any information or data from among (Y1) to (Y6).

### (1.3) Arrangement Example of Functional Blocks in “Positioning Accuracy Enhancement”

An arrangement example of the functional blocks in the “positioning accuracy enhancement” will be described. The “positioning accuracy enhancement” represents, for example, a use case where the accuracy of the position information measured by the UE 100 is enhanced using the machine learning technology.

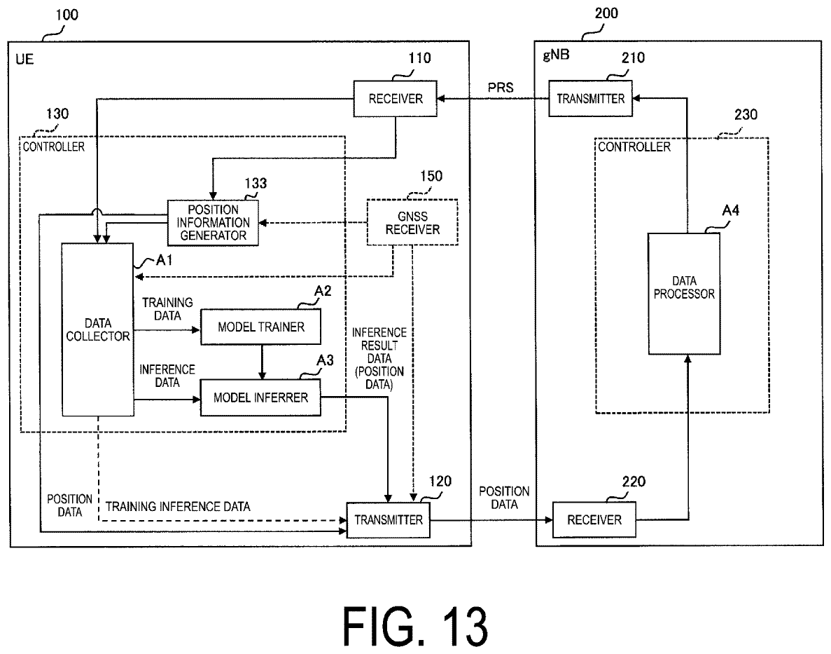

FIG. 13 is a diagram illustrating an arrangement example of the functional blocks in the “positioning accuracy enhancement”. In the example of the “positioning accuracy enhancement” illustrated in FIG. 9, the controller 130 of the UE 100 includes the data collector A1, the model trainer A2, and the model inferrer A3. On the other hand, the controller 230 of the gNB 200 includes the data processor A4. In other words, FIG. 13 illustrates an example in which the UE 100 performs model training and model inference. FIG. 13 illustrates an example in which the transmission entity TE is the UE 100 and the reception entity RE is the gNB 200.

As illustrated in FIG. 13, the UE 100 includes a position information generator 133. The UE 100 may include a Global Navigation Satellite System (GNSS) reception device 150. The position information generator 133 generates position data of the UE 100 based on a Positioning Reference Signal (PRS) received from the gNB 200. The position information generator 133 may receive a GNSS signal (full GNSS signal or partial GNSS signal) received by the GNSS reception device 150 and generate the position data of the UE 100 based on the GNSS signal.

Note that, as is the case with the full CSI-RS, the gNB 200 transmits the full PRS using a predetermined amount of first resources (for example, all antenna ports as illustrated in FIG. 9 or a predetermined amount of time frequency resources as illustrated in FIG. 10). Similarly to the partial CSI-RS, the gNB 200 transmits the partial PRS using second resources the amount of which is smaller than that of the first resources (g for example, half of the antenna ports in the antenna panel as illustrated in the ninth, or half of the predetermined amount of time frequency resources as shown in FIG. 10).

The full GNSS signal may be a GNSS signal temporally continuously received by the GNSS reception device 150. The partial GNSS signal may be a GNSS signal intermittently received by the GNSS reception device 150. In other words, a predetermined amount of first resources may be used for the full GNSS signal, and the second resources the amount of which is smaller than that of the first resources may be used for the partial GNSS signal.

An operation example in the “position accuracy improvement” can be implemented by replacing the “full CSI-RS” with the “full PRS”, the “partial CSI-RS” with the “partial PRS”, and the “CSI feedback” with the “position data” in FIG. 11.

In the training mode (step S103), the position information generator 133 generates the position data of the UE 100 based on the full PRS received from the gNB 200. The position information generator 133 may receive a full GNSS signal received by the GNSS reception device 150 and generate the position data of the UE 100 based on the full GNSS signal. The transmitter 120 feeds back (or transmits) the position data to the gNB 200. The data collector A1 collects the full PRS (or the full GNSS signal) and the position data. The model trainer A2 generates a trained model using the full PRS (or the full GNSS signal) and the position data as training data.

In the inference mode (step S108), the data collector A1 collects the partial PRS received by the receiver 110 (or the partial GNSS signal received by the GNSS reception device 150). The model inferrer A3 causes the partial PRS (or the partial GNSS signal) and the position data to be input to the trained model as inference data, and obtains the position data as an inference result. The UE 100 transmits the inference result (position data) to the gNB 200 as inference result data.

In the “positioning accuracy enhancement”, in addition to the “PRS”, the “GNSS signal”, and the “position data”, for example, at least one selected from the group consisting of the following data or information may be used as the data used for the dataset.

(Z1) RSRP, RSRQ, Signal-to-interference-plus-noise ratio (SINR), or the output waveform of the AD converter (a measurement target of these data may be the PRS. The measurement target may be other reception signals received from the gNB 200)

(Z2) Line Of Sight (LOS) or Non Line Of Sight (NLOS)

(Z3) Measurement timing, accuracy, likelihood

(Z4) RF fingerprint (cell ID and reception quality in the cell having the cell ID)

(Z5) Angle of Arrival (AOA) of a reception signal, a reception level for each antenna, a reception phase for each antenna, and an Observed Time Difference Of Arrival (OTDOA) for each antenna

(Z6) Reception information of a beacon used in short-range wireless communication such as wireless Local Area Network (LAN) such as Wi-Fi (trade name), or Bluetooth (trade name)

(Z7) Moving speed of the UE 100 (the moving speed may be measured by the GNSS reception device 150. The moving speed may be measured by a speed sensor in the UE 100) The UE 100 may transmit capability information as the control data to the gNB 200, the capability information indicating which type of input data the UE 100 can handle in the machine learning. The capability information may include any information or data from among (Z1) to (Z7). Aside from the training data and the inference data, the capability information may include any information or data from among (Z1) to (Z7). The gNB 200 may transmit the data type information used as a dataset, to the UE 100 as the control data. The data type information may include, for example, any of the data or information indicated in (Z1) to (Z7). Aside from the training data and the inference data, the data type information may include any information or data from among (Z1) to (Z7).

### (1.4) Other Arrangement Examples

Other arrangement examples will be described next.

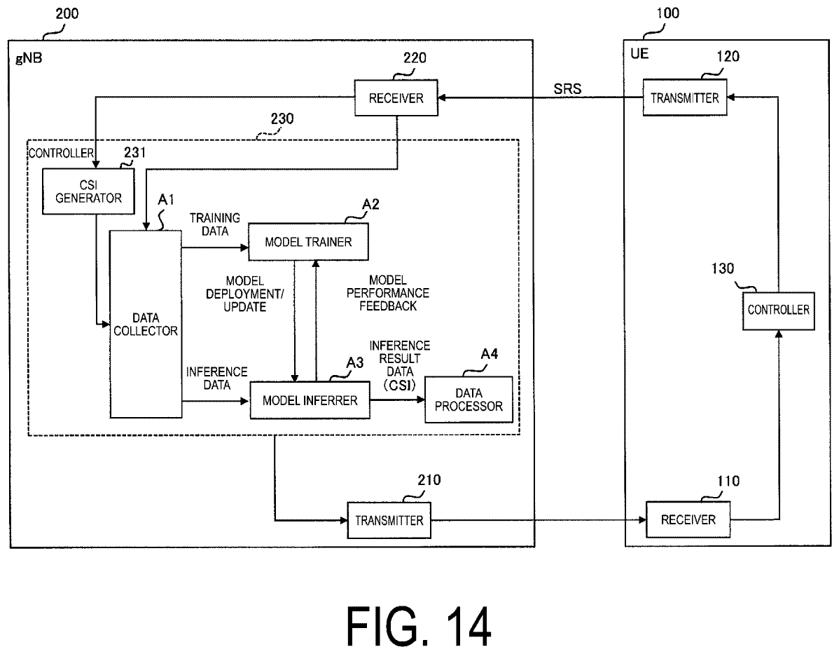

FIG. 14 is a diagram illustrating another arrangement example of the “CSI feedback enhancement” according to the first embodiment. FIG. 14 illustrates an example in which the gNB 200 includes the data collector A1, the model trainer A2, the model inferrer A3, and the data processor A4. In other words, FIG. 14 illustrates an example in which the gNB 200 performs model training and model inference. FIG. 14 illustrates an example in which the transmission entity TE is the gNB 200 and the reception entity RE is the UE 100.

FIG. 14 illustrates an example in which the AI/ML technology is introduced into CSI estimation performed by a gNB 200 based on a Sounding Reference Signal (SRS). Thus, the gNB 200 includes a CSI generator 231 that generates CSI based on the SRS. The CSI is information indicating an uplink channel state between the UE 100 and the gNB 200. The gNB 200 (e.g., the data processor A4) performs, for example, uplink scheduling based on the CSI generated based on the SRS.

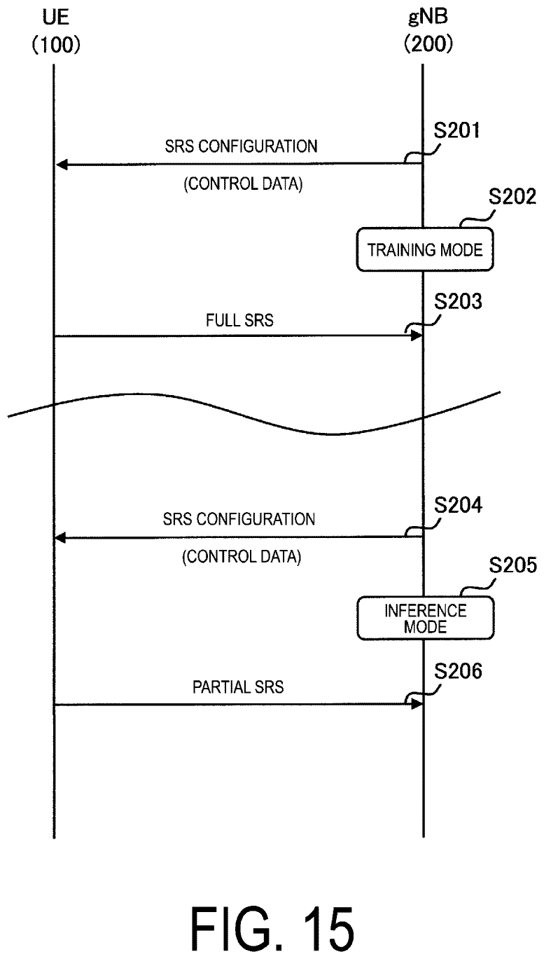

FIG. 15 is a diagram illustrating an operation example in another arrangement example according to the first embodiment.

As illustrated in FIG. 15, in step S201, the gNB 200 provides SRS configuration for the UE 100. The SRS transmission configuration may include type information of the reference signal transmitted by the UE 100.

In step S202, the gNB 200 starts the training mode.

In step S203, the UE 100 transmits a full SRS to the gNB 200 in accordance with the SRS transmission configuration (step S201). The receiver 220 of the gNB 200 receives the full SRS. In the training mode, the CSI generator 231 generates (or estimates) CSI based on the full SRS. The data collector A1 collects the full SRS and the CSI. The model trainer A2 uses the full SRS and the CSI as training data to generate a trained model.

In step S204, the gNB 200 specifies the transmission pattern (puncture pattern) of the SRS to be input to the trained model as the inference data, and configures the specified SRS transmission pattern for the UE 100. The gNB 200 may transmit, to the gNB 200, the SRS transmission configuration including the specified SRS transmission pattern.

In step S205, the gNB 200 switches from the training mode to the inference mode. The gNB 200 starts the model inference using the trained model.

In step S206, the UE 100 transmits the partial SRS in accordance with the SRS transmission configuration (step S204). When the gNB 200 inputs the SRS as the inference data to the trained model to obtain a channel estimation result, the gNB 200 performs uplink scheduling (e.g., control of uplink transmission weights and the like) of the UE 100 by using the channel estimation result. Note that when the inference accuracy achieved by the trained model deteriorates, the gNB 200 may reconfigure the UE 100 to cause the UE 100 to transmit the full SRS.

(1.5) Arrangement Example when Federated Learning is Performed

An arrangement example of the functional blocks used when federated learning is performed will be described. The federated learning is, for example, one approach for machine learning in which machine learning is performed in a state where data (or a dataset) is not aggregated but distributed. In the federated learning, each entity does not need to transmit data, and thus the security of the entity can be ensured. The federated learning is considered to be able to obtain a training result with accuracy equivalent to that of the conventional centralized machine learning.

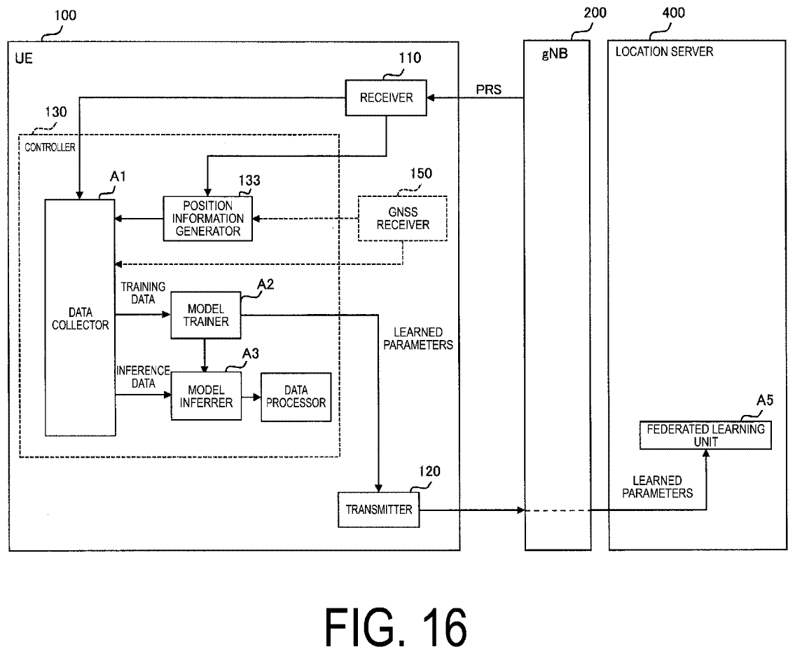

FIG. 16 is a diagram illustrating an arrangement example in which the federated learning according to the first embodiment is performed. The example illustrated in FIG. 16 illustrates an example of a case in which the position estimation of the UE 100 is performed using the federated learning. FIG. 16 illustrates an example in which the UE 100 includes the data collector A1, the model trainer A2, and the model inferrer A3. In other words, FIG. 16 illustrates an example in which the UE 100 performs model training and model inference. FIG. 16 illustrates an example in which the UE 100 is the transmission entity TE and the gNB 200 and/or a location server 400 is the reception entity RE.

The federated learning illustrated in FIG. 16 is performed in the following procedure, for example.

First, the location server 400 transmits, to the UE 100, the model on which model training is based.

Second, the UE 100 (model trainer A2) performs model training using the data present in the UE 100. The data present in the UE 100 may be, for example, a PRS received from the gNB 200 and/or output data (GNSS signal) from the GNSS reception device 150. The data present in the UE 100 may include position data generated by the position information generator 133 based on the reception result of the PRS and/or the output data from the GNSS reception device 150.

Third, the UE 100 applies the trained model, which is the training result, to the model inferrer A3 and transmits, to the location server 400, variable parameters included in the trained model (hereinafter also referred to as “learned parameters”). In the above example, the optimized a (slope) and b (intercept) correspond to the learned parameters.

Fourth, the location server 400 (federated learning unit A5) collects the learned parameters from a plurality of UEs 100 and integrates these parameters. The location server 400 may transmit, to the UE 100, the trained model obtained by the integration. The location server 400 can estimate the position of the UE 100 based on the trained model and a measurement report from the UE 100.

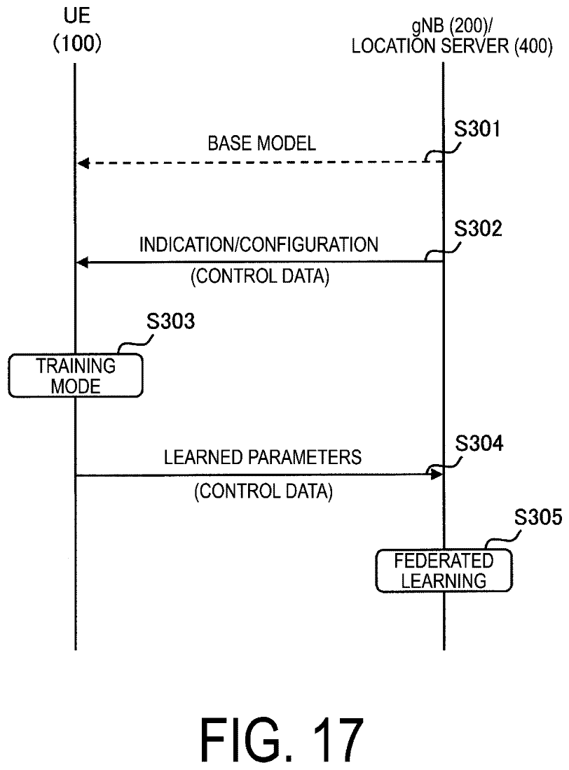

FIG. 17 is a diagram illustrating an operation example in the federated learning according to the first embodiment.

As illustrated in FIG. 17, in step S301, the gNB 200 may notify the UE 100 of a model on which learning of the UE 100 is based. The location server 400 may notify the UE of the model via the gNB 200.

In step S302, the gNB 200 indicates the UE 100 about model training. The gNB 200 may configure a report timing (trigger condition) of the learned parameters. The report timing may be a periodic timing. The report timing may be a timing triggered by learning proficiency satisfying a condition (i.e., an event trigger).

In step S303, the UE 100 starts the training mode. The UE 100 performs model training using, as the training data, the full PRS (or the full GNSS signal) and the position data generated by the position information generator 133.

In step S304, when the condition of the report timing is satisfied, the UE 100 transmits, to the network (gNB 200 or location server 400) the learned parameters obtained at that time.

In step S305, the location server 400 integrates the learned parameters reported from a plurality of UEs 100.

### (1.6) Model Transfer Example

In (1.1) to (1.5), the arrangement example of the functional blocks of the AI/ML technology has been described. A model transfer example will be described below. The model to be transferred may be a trained model used in the model inference. The model may be an untrained model used in the model training (or a model being trained).

### (1.6.1) First Operation Pattern Relating to Model Transfer

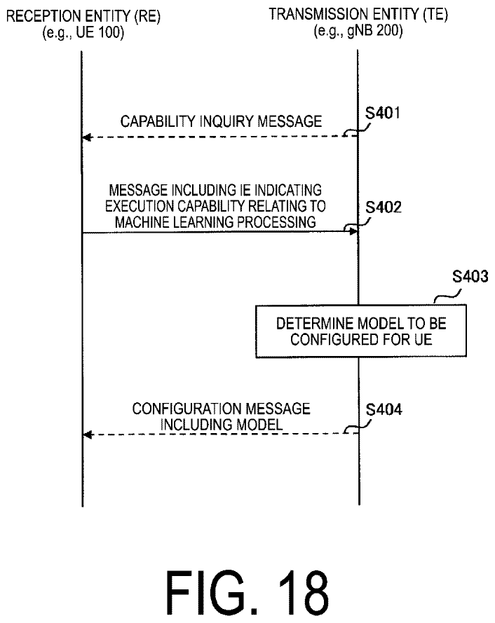

FIG. 18 is a diagram illustrating an operation example of a first operation pattern relating to model transfer according to the first embodiment. In the example illustrated in FIG. 18, the reception entity RE is mainly described as the UE 100. However, the reception entity RE may be the gNB 200 or AMF 300. In the example illustrated in FIG. 18, the transmission entity TE is mainly described as the gNB 200. However, the transmission entity TE may be the UE 100 or AMF 300.

As illustrated in FIG. 18, in step S401, the gNB 200 transmits, to the UE 100, a capability inquiry message for requesting transmission of the message including the information element (IE) indicating the execution capability relating to the machine learning processing. The UE 100 receives the capability inquiry message. However, the gNB 200 may transmit the capability inquiry message when performing the machine learning processing (when determining to perform the machine learning process).

In step S402, the UE 100 transmits, to the gNB 200, the message including the information element indicating the execution capability (an execution environment for the machine learning processing, from another viewpoint) relating to the machine learning processing. The gNB 200 receives the message. The message may be an RRC message, for example, a “UE Capability” message or a newly defined message (e.g., a “UE AI Capability” message or the like). Alternatively, the transmission entity TE may be the AMF 300 and the message may be a NAS message. When a new layer for performing or controlling the machine learning processing (AI/ML processing) is defined, the message may be a message of the new layer.

The information element indicating the execution capability relating to the machine learning processing may be an information element indicating capability of a processor for performing the machine learning processing and/or an information element indicating capability of a memory for performing the machine learning processing. Specifically, the information element indicating the capability of the processor may be an information element indicating a product number (or model number) of an AI processor. Specifically, the information element indicating the capability of the memory may be an information element indicating the memory capacity.

Alternatively, the information element indicating the execution capability relating to the machine learning processing may be an information element indicating the execution capability of the inference processing (model inference). The information element indicating the execution capability of the inference processing may be an information element indicating whether a deep neural network model can be supported. The information element may indicate the time (response time) required to execute the inference processing.

Alternatively, the information element indicating the execution capability relating to the machine learning processing may be an information element indicating the execution capability of the learning processing (model training). The information element indicating the execution capability of the learning processing may be an information element indicating the number of simultaneous executions of the learning processing. The information element may indicate the processing capacity of the learning processing.

In step S403, the gNB 200 determines a model to be configured (deployed) for the UE 100 based on the information element included in the message received in step S402.

In step S404, the gNB 200 transmits, to the UE 100, a message including the model determined in step S403. The UE 100 receives the message and performs the machine learning processing (i.e., model learning processing and/or model inference processing) using the model included in the message. A specific example of step S404 will be described in a second operation pattern below.

### (1.6.2) Second Operation Pattern Relating to Model Transfer

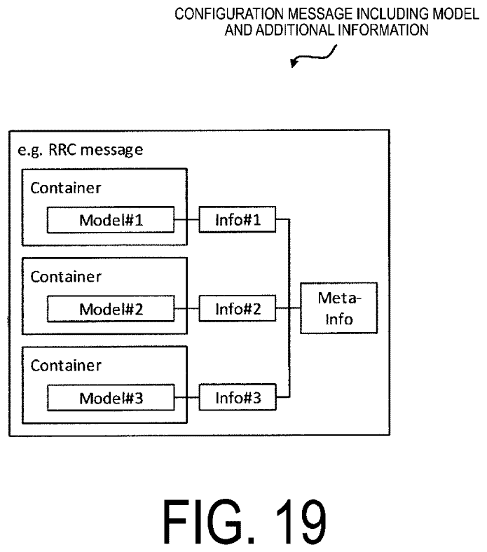

FIG. 19 is a diagram illustrating an example of a configuration message including models and additional information according to the first embodiment. The configuration message may be an RRC message transmitted from the gNB 200 to the UE 100 (for example, an “RRC Reconfiguration” message, or a newly defined message (for example, an “AI Deployment” message, an “AI Reconfiguration” message, or the like). Alternatively, the configuration message may be a NAS message transmitted from the AMF 300 to the UE 100. When a new layer for performing or controlling the machine learning processing (AI/ML processing) is defined, the message may be a message of the new layer.

In the example of FIG. 19, the configuration message includes three models (Model #1 to Model #3). Each model is included as a container of the configuration message. However, the configuration message may include only one model. The configuration message further includes, as the additional information, three pieces of individual additional information (Info #1 to Info #3) individually provided corresponding to three models (Model #1 to Model #3), respectively, and common additional information (Meta-Info) commonly associated with three models (Model #1 to Model #3). Each piece of individual additional information (Info #1 to Info #3) includes information unique to the corresponding model. The common additional information (Meta-Info) includes information common to all models in the configuration message.

The individual additional information may be a model index representing an index (index number) assigned to each model. The individual additional information may be a model execution condition indicating performance (for example, processing delay) required for applying (executing) the model.

The individual additional information or the common additional information may be a model application designating a function to which the model is applied (for example, “CSI feedback”, “beam management”, “position measurement”, or the like). The individual additional information or the common additional information may be a model selection criterion for applying (executing) a corresponding model in response to satisfaction of a designated criterion (for example, a moving speed).

### (1.7) Communication Control Method According to First Embodiment

A communication control method according to the first embodiment will be described. As described above, Non-Patent Document 1 discloses that when an AI algorithm was applied to DRX and a simulation for predicting the next traffic burst was performed, delay was successfully significantly reduced with power consumption same as, and/or similar to, that of the conventional DRX configuration.

However, in Non-Patent Document 1, the result of the prediction by the AI algorithm assumes that a DRX operation is performed in such a manner as to coincide with a next traffic burst. However, Non-Patent Document 1 does not specifically indicate how the DRX operation is performed. Non-Patent Document 2 also discusses specifying a use case of a high layer to which the AI/ML model is applied, but does not specifically discuss how the AI algorithm is applied to the DRX operation.

Thus, an object of the first embodiment is to enable the mobile communication system 1 to appropriately execute DRX by using the AI/ML model.

### (1.7.1) DRX

Here, DRX according to the first embodiment will be described.

DRX is, for example, a technique that causes the UE 100 to discontinuously monitor the PDCCH. The (MAC entity) of the UE 100 configured with the DRX applies a DRX operation to the active serving cell to discontinuously monitor the PDCCH. In other words, the UE 100 configured with DRX, for example, turns off the radio communication function in the “sleep” mode, and monitors the PDCCH in the “wake-up” mode. Periodically repeating the “sleep” mode and the “wake-up” mode may be referred to as DRX. DRX provides a period when the UE 100 is in the “sleep” mode, and can thus reduce power consumption of the UE 100 compared to a case where the UE 100 constantly monitors the PDCCH.

In order to enable the UE 100 to perform a DRX operation, the gNB 200 notifies the UE 100 of a DRX configuration (DRX-Config). The gNB 200 notifies the UE 100 of the DRX configuration by transmitting, to the UE 100, an RRC message (for example, RRC reconfiguration (RRCReconfiguration) message, RRC resume (RRCResume) message, or RRC setup (RRCSetup) message) including the DRX configuration.

The DRX configuration includes an “on-duration” in DRX (“drx-onDurationTimer”), a “DRX cycle” representing one cycle in DRX (“drx-LongCycleStartOffset”), a “delay time” before the start of “drx-onDurationTimer” (“drx-SlotOffset”), an “inactive timer” representing a duration time for performing new DL transmission (or UL transmission) after PDCCH reception (“drx-InactivityTimer”), and the like.

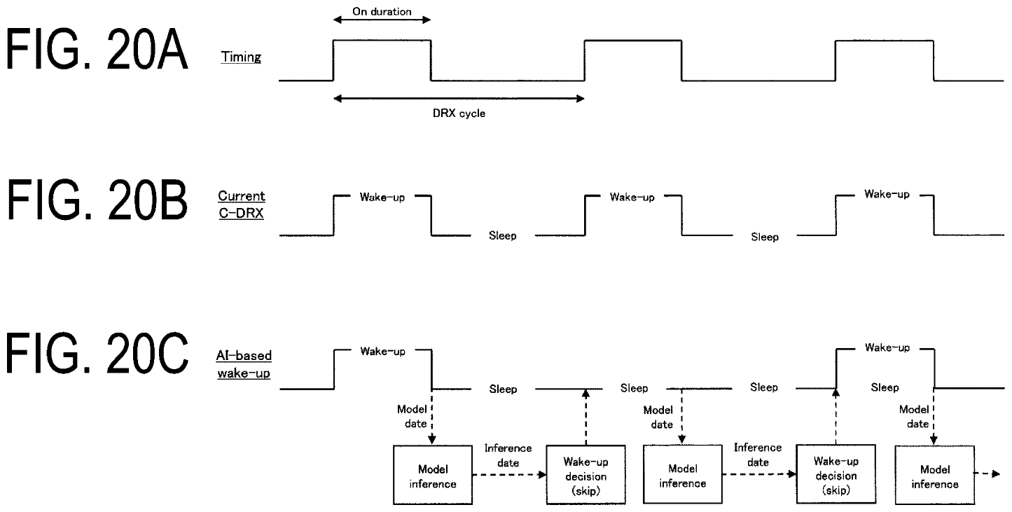

FIGS. 20A and 20B are diagrams illustrating an example of the DRX cycle according to the first embodiment. The UE 100 is configured with a DRX cycle and a DRX on-duration based on the DRX configuration. During the on-duration, the UE 100 is in a wake-up mode and monitors the PDCCH. On the other hand, during a period other than the on-duration, the UE 100 is in the sleep mode and turns off some of the functions without monitoring the PDCCH. In the wake-up mode, the UE 100 can perform SRS transmission, transmission of feedback information, or the like in addition to monitoring of the PDCCH.

Upon receiving a DRX command (DRX Command MAC CE that is a MAC Control Element (CE)) during the on-duration, the UE 100 stops (or ends) the “on-duration” to refrain from monitoring the PDCCH.

The above-described DRX configuration basically represents a configuration of a long DRX cycle. In the DRX configuration, a short DRX cycle shorter than the long DRX cycle can be configured as an option. In other words, possible DRX configurations include the “short DRX cycle” (“drx-ShortCycle”) and the “duration” (“drx-ShortCycleTimer”) during which the UE 100 continues the short DRX cycle. By this means, the “short DRX cycle” can be configured in the off period of the long DRX configuration.

The above-described DRX control has been described with an example of connected mode DRX (C-DRX) in which the DRX operation is performed when the UE 100 is in the RRC connected state. In an idle mode DRX (I-DRX) in which the UE 100 performs a DRX operation when in the RRC idle state or the RRC inactive state. In this case, the UE 100 and the gNB 200 use an identifier of the UE 100 (IMSI: International Mobile Subscriber Identity, 5G S-TMSI (Temporary Mobile Subscriber Identity), or the like) to calculate a paging occasion (PO), which is a subframe in which a paging message is transmitted, and a paging frame (PF), which is a radio frame including the PO. When the gNB 200 transmits the paging message in the periodic PF, the UE 100 can receive the paging message. The embodiments will be described below mainly taking C-DRX as an example. However, the embodiments may be applied to I-DRX unless otherwise specified.

In the above, DRX has been described.

The existing DRX control has, for example, the following problems. In other words, if no DL data (data in the downlink) is present when the UE 100 is in the wake-up state, the wake-up is wasted from the viewpoint of power consumption of the UE 100. When the timing at which DL data is input to the gNB 200 does not coincide with the on-duration of DL data, the UE 100 waits for reception of DL data until the next on-duration, and the waiting time corresponds to latency. Such a problem between power consumption and latency is desired to be solved by DRX control by using the AI/ML model.

### (1.7.2) Term

Terms used in the embodiments will be described.

Hereinafter, the on-duration of DRX may be simply referred to as an “on-duration”. The “on-duration” may be referred to as a transmission opportunity of DL data (data in the downlink).

The “wake-up mode” may be simply referred to as “wake-up”. When the DRX configuration is performed, the UE 100 basically “wakes up” in the on-duration and monitors the PDCCH or the like. The “wake-up” may be turning on the reception device. Alternatively, the “wake-up” may be monitoring the PDCCH.

The “sleep mode” may be simply referred to as “sleep”.

The “AI/ML model” is, for example, a data-driven algorithm that applies, for example, a machine learning technology to generate a series of outputs including prediction information and/or parameters based on a series of inputs. The “AI/ML model” may be a “learned algorithm” that receives inference data as inputs and outputs inference result data. Hereinafter, the “AI/ML model” and the “trained model” may be used without distinction. The “AI/ML” model may be referred to as an “inference model”. The inference model may be the “trained model”.

### (1.7.3) First Operation Example According to First Embodiment

A first operation example according to the first embodiment will be described.

In the first operation example, the UE 100 uses the AI/ML model to infer whether DL data traffic will occur in the next on-duration, and based on the inference result, either wakes up or skips the wake-up in the next on-duration.

To be more specific, first, the user equipment (for example, the UE 100) uses the AI/ML model to infer whether downlink data traffic is to occur in the next DRX on-duration. Second, the user equipment performs one of wake-up or skipping of wake-up in the next DRX on-duration based on the inference result for occurrence or non-occurrence of the data traffic.

In this way, upon inferring non-occurrence of DL data traffic during the on-duration, the UE 100 skips the wake-up during the on-duration. On the other hand, upon inferring occurrence of DL data traffic during the on-duration, the UE 100 performs a wake-up operation during the on-duration. Thus, for example, the UE 100 can perform a DRX operation reflecting an inference result obtained by using the AI/ML model, and can appropriately perform DRX by using the AI/ML model. Since the UE 100 may skip the wake-up in the on-duration, this enables a reduction in power consumption of the UE 100 as compared with a case where the UE always wakes up in the on-duration.

In the first operation example, the UE 100 includes the AI/ML model, and performs model inference based on the AI/ML model. The first operation example represents an example of “UE-side one-sided model” in which the AI/ML model is present on the UE 100 side.

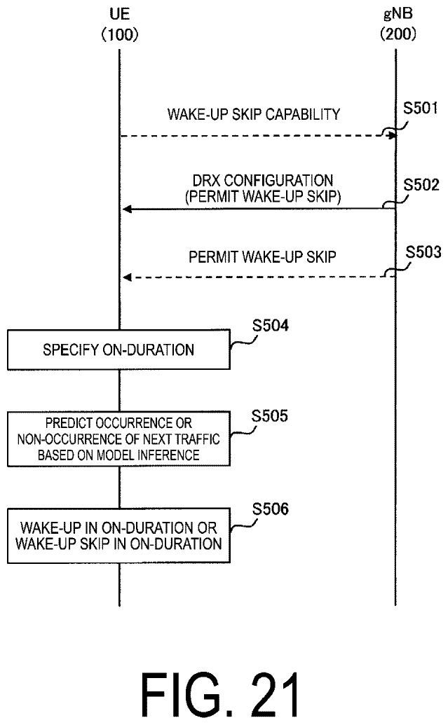

FIG. 21 illustrates a first operation example according to the first embodiment.

As illustrated in FIG. 21, in step S501, UE 100 may notify the gNB 200 that the UE has the capability of skipping the wake-up. The UE 100 may perform the notification by transmitting an RRC message including information indicating the presence or absence of the capability (for example, a UE capability (UECapability) message). “Wake-up skip” may represent skipping the on-duration (“on-duration skip”). The notification may mean that the UE 100 has an AI-based DRX capability. Alternatively, the indication may mean that the UE 100 includes an inference model (or trained model) for DRX optimization.

In step S502, the gNB 200 performs DRX configuration for the UE 100. Specifically, the gNB 200 may perform the configuration by transmitting, to the UE 100, an RRC message including the DRX configuration (for example, RRC reconfiguration (RRCReconfiguration) message). The DRX configuration may include various existing information elements (IEs) such as “drx-onDurationTimer”. The DRX configuration may include permission information for permitting the wake-up to be skipped in the on-duration. According to the permission information, the gNB 200 configures the UE 100 with permission to skip the wake-up in the on-duration, and gives the UE 100 discretion to skip the wake-up. The permission information may be notified to the UE 100 by using MAC-CE or DCI (step S503). The permission information may be information that does not permit the wake-up skip instead of information that permits the wake-up skip. The permission information may be information indicating one of permission or non-permission of the wake-up skip. Note that a target of the permission information may be configured for each model. The target may be configured for all models.

In step S504, the UE 100 specifies a DRX cycle and an on-duration within the DRX cycle based on the DRX configuration.

In step S505, the UE 100 uses an inference model to perform model inference to infer occurrence or non-occurrence of DL data traffic in the next on-duration.

First, the UE 100 selects an inference model associated with the currently running application. When data transmission or RRC signaling is used for the application, the UE 100 may select an inference model based on the data transmission or the RRC signaling. A plurality of inference models may be selected as the inference model. In this case, the UE 100 may execute the plurality of inference models in parallel (or simultaneously). The UE 100 may infer occurrence or non-occurrence of DL data traffic based on the inference results from the plurality of inference models.

Second, for the UE 100, the inference data input to the inference model and the inference result data output from the inference model are, for example, as follows. In other words, the inference data is information indicating whether DL data has been generated in the current on-duration (or whether the UE 100 has received DL data). The inference data may be information indicating whether DL data was generated in the past on-duration. When the MAC-layer of the UE 100 receives information on traffic characteristics from a higher layer (for example, the application layer), the information may be used as the inference data. On the other hand, the inference result data is information indicating whether DL data traffic is to occur in the next on-duration. A wake-up decision result (wake-up or wake-up skip is performed) described below may be used as inference result data. Note that although occurrence of DL data traffic is inferred by using the AI/ML model in the first operation example, the DL data traffic may be inferred by a method other than the AI/ML model, such as statistical processing of past data, instead of the AI/ML model.

Third, the UE 100 makes a wake-up decision. To be more specific, the UE 100 performs one of wake-up or skipping of wake-up in the next on-duration based on the inference result for occurrence or non-occurrence of DL data traffic.

Upon inferring occurrence of DL data traffic, the UE 100 wakes up in the next on-duration. In a case of selecting a plurality of inference models, the UE 100 may decide to wake up when a logical sum of inference results from the respective inference models is true. In other words, when obtaining, from at least one inference model, an inference result indicating occurrence of DL data traffic, the UE 100 may decide to wake up.

On the other hand, when inferring non-occurrence of DL data traffic, the UE 100 skips the wake-up in the next on-duration. In a case of selecting a plurality of inference models, the UE 100 may decide to skip the wake-up when a logical sum of inference results from the respective inference models is false. In other words, when obtaining, from all inference models, an inference result indicating that DL data traffic is not to occur, the UE 100 may decide to skip the wake-up. The wake-up skip may be to continue the sleep. Alternatively, the wake-up skip may be one of turning off the reception device or not turning on the reception device. Alternatively, the wake-up skip may be to skip monitoring of the PDCCH. The wake-up skip may be not monitoring the PDCCH. The wake-up skip may cause the UE 100 to go into the sleep mode.

Fourth, the UE 100 may adjust the wake-up period in accordance with the probability of occurrence of DL data traffic. For example, the UE 100 calculates the generation probability of DL data in the on-duration, and wakes up during a period shorter than the on-duration when the generation probability is lower than a threshold value, and wakes up during a period longer than the on-duration when the generation probability is equal to or higher than the threshold value. The threshold value may be configured by the gNB 200.

In step S506, UE 100 wakes up or skips the wake-up in the next on-duration in accordance with the decision result of the wake-up decision. Ideally, the UE 100 wakes up at the timing when DL data traffic occurs. This enables a reduction in power consumption of the UE 100 to maximize the DRX effect in a standby state as compared with the case where the UE 100 always wakes up in the on-duration.

FIG. 20C is a diagram illustrating a sequence flow of wake-up decisions according to the first embodiment. As illustrated in FIG. 20C, the UE 100 performs model inference and decides to skip the wake-up in the next on-duration based on the inference result. The UE 100 also decides whether to skip the wake-up for the next on-duration. Subsequently, the UE 100 repeats this process, obtains an inference result regarding occurrence or non-occurrence of DL data traffic using the inference model, and makes the wake-up decision in the next on-duration based on the inference result.

### (1.7.4) Another Example of First Operation Example According to First Embodiment

Another example of the first operation example according to the first embodiment will be described.

In the first operation example, the UE 100 skipping the wake-up has been described. In this case, for example, although the UE 100 has performed the wake-up skip, the UE 100 does not know whether no DL data has really been present (or whether DL data has been present). On the other hand, gNB 200 can recognize that although the gNB 200 has transmitted DL data, the UE 100 has not received the data, by using HARQ feedback (no HARQ feedback is provided for a certain period of time, NACK is returned, or the like).

Thus, the gNB 200 may provide the UE 100 with information indicating the presence or absence of DL data for each on-duration, and the UE 100 may perform model training using the information. The gNB 200 may transmit, to the UE 100, timing information for the on-duration (for example, a radio frame number, a subframe number, a slot number, or the like) and information regarding the presence or absence of DL data (for example, 1-bit information). The gNB 200 may transmit, to the UE 100, information of the bearer in which DL data has been generated (for example, a bearer ID of the bearer). For example, the gNB 200 may transmit these pieces of information using the RRC message. The gNB 200 may transmit the information in response to a request from the UE 100. The gNB 200 may transmit the information upon determining that the reception status of the UE 100 is not good.

### (1.8) Second Operation Example According to First Embodiment

A second operation example according to the first embodiment will be described. Differences of the second operation example from the first operation example will be mainly described.

In the first operation example, the case where the UE 100 may skip the wake-up during the on-duration has been described.

Here, for example, the following case is assumed. In other words, there is a case where the inference model infers non-occurrence of DL data traffic for a long time for some reason such as an estimation error due to overfitting. In such a case, the UE 100 continues the wake-up skip, and communication with the gNB 200 is disabled for a long time. Therefore, even when DL data traffic has occurred, the DL data is not transmitted to the UE 100 for a long time, resulting in increased latency. Neither DL data nor control-related signaling is transmitted, and the control of the UE 100 is disabled for a long time.

Thus, in the second operation example, an example in which the gNB 200 restricts the wake-up skip for the UE 100 will be described. Specifically, the base station (for example, the gNB 200) configures the user equipment (for example, the UE 100) with an operation restriction on the wake-up skip.

As described above, for example, since the operation restriction is imposed on the wake-up skip in the UE 100, increased latency can be avoided that is caused by long-continued wake-up skip, enabling avoidance of long-continued uncontrollability of the UE 100. The wake-up skip of the UE 100 is also allowed under a certain condition, and thus, like the first operation example, the second operation example enables a reduction in the power consumption of the UE 100.

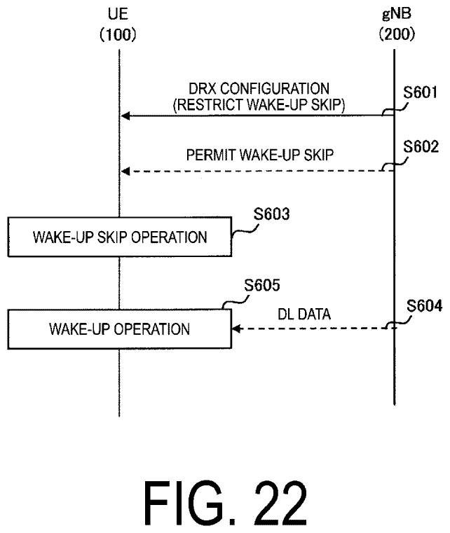

FIG. 22 is a diagram illustrating the second operation example according to the first embodiment.

As illustrated in FIG. 22, in step S601, the gNB 200 provides the DRX configuration for the UE 100. The DRX configuration includes information related to the operation restriction on the wake-up skip (which may hereinafter be referred to as “restriction information”).

First, the restriction information may be information for restricting the number of consecutive executions of the wake-up skip. The UE 100 counts the number of wake-up skips using a counter, and when the number of consecutive executions reaches an upper limit number (or exceeds the upper limit number), refrains from performing the wake-up skip regardless of an inference result from the inference model. The restriction information may be the upper limit of the number of consecutive executions of the wake-up skip. Hereinafter, a method of counting the number of wake-up skips using the counter as described above may be referred to as a “counter method”.

Second, the restriction information may be information for restricting the continuous execution time of the wake-up skip. The restriction information may be a timer value indicating the upper limit time of the continuous execution time of the wake-up skip. In other words, when the timer starts counting and the count value reaches the timer value (or exceeds the upper limit time or the timer value expires), the UE 100 refrains from performing the wake-up skip regardless of the inference result from the inference model. Hereinafter, the method of counting the continuous execution time of the wake-up skip using the timer as described above may be referred to as a “timer method”.

Third, the restriction information may be a repetition period during which the UE 100 must wake up. The repetition period is referred to as a “wake-up period”.

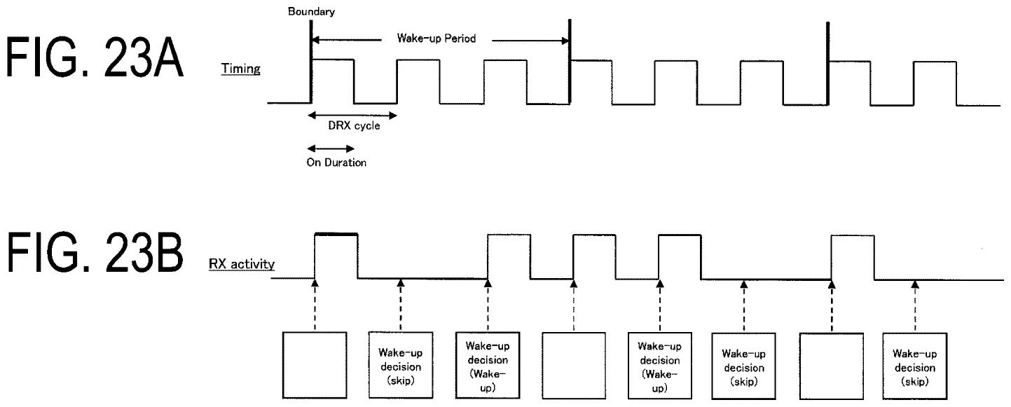

FIGS. 23A and 23B are diagrams illustrating timing examples according to the first embodiment. As illustrated in FIGS. 23A and 23B, the UE 100 wakes up in the on-duration at the boundary of the wake-up period regardless of the inference result for the DL data traffic obtained from the inference model, and repeats this for each wake-up period. During on-durations other than this on-duration, the UE 100, the UE 100 wakes up or skips the wake-up in accordance with the inference result from the inference model. Note that the period during which the UE 100 must wake up may be the on-duration following the boundary. Alternatively, the period during which the UE 100 must wake up may be any on-duration within the wake-up period. The on-duration is a repetition period during which the UE 100 does not perform the wake-up skip.

First, the DRX configuration includes information related to a reference point (or start timing) of the wake-up period. The presence of the reference point (or start timing) allows the gNB 200 to specify a transmission opportunity for DL data and to transmit the DL data in a pinpoint manner.

Second, the DRX configuration may include an offset of the wake-up period (a timing offset from the start timing).

Third, the DRX configuration may include the length of the wake-up period. The length of the wake-up period may be represented by an absolute value (e.g., the number of slots). The length may be represented by a scale value (e.g., a multiple of the DRX cycle). The wake-up period is represented by a period synchronized with the DRX cycle.

Fourth, the DRX configuration may include information indicating in which on-duration during the wake-up period the UE 100 wakes up. When the UE 100 wakes up in an on-duration other than the reference point, the DRX configuration may include information indicating the on-duration during which the UE 100 wakes up.

As described above, the gNB 200 may configure the UE 100 with the operation restriction on the wake-up skip through the DRX configuration.

Referring back to FIG. 22, in step S602, the gNB 200 may transmit, to the UE 100, permission information for permitting the wake-up to be skipped in the on-duration. As in the first embodiment, the gNB 200 may include the permission information in the DRX configuration (step S601). The gNB 200 may separately transmit the permission information using a MAC CE or DCI.

In step S603, as is the case with the first embodiment, the UE 100 configures DRX in accordance with the DRX configuration and uses the inference model to infer the DL data traffic in the next on-duration. The UE 100 skips wake-up in the next on-duration based on the inference result.

First, in the case of the “counter method”, for example, the wake-up skip operation is restricted as follows. In other words, the UE 100 resets the counter (or sets the counter to 0 (or sets the timer value)) upon waking up, and increments the count value of the counter by 1 every time the UE 100 performs the wake-up skip. Alternatively, the UE 100 may reset the counter upon performing the wake-up skip for the first time after waking up, and may increment the counter by 1 when performing the wake-up skip during the last and current on-durations. Alternatively, the UE 100 may reset the counter upon successfully receiving DL data (for example, when transmitting HARQ ACK). When the counter value reaches or exceeds the upper limit value (control information), the UE 100 wakes up in the next on-duration instead of skipping the wake-up regardless of the inference result from the inference model.

In the above-described example, the example of the “count method” in which the number of wake-up skips is counted has been described. However, the target of the counting may be the on-duration. In other words, the UE 100 resets the counter (or sets the counter to 0 (or sets the timer value)) in the on-duration used as a start point (reference point), and increments the counter by 1 at the next on-duration. When the count reaches (or exceeds) the upper limit value (restriction information), the UE 100 wakes up without skipping the wake-up in the corresponding on-duration (or the next on-duration) regardless of the inference result from the inference model.

Second, in the case of the “timer method”, for example, the operation of the wake-up skip is restricted as follows. In other words, when waking up, the UE 100 resets the count value of the timer (or sets the count value to 0 (or sets the timer value)) and causes the timer to start counting. The UE 100 may cause the timer to start counting (or reset the counter or set the counter to 0 (or set the timer value)) when performing the first wake-up skip after waking up. Alternatively, the UE 100, the UE 100 may cause the timer to start counting (or reset the counter or set the counter to 0 (or set the timer value)) when successfully receiving DL data (for example, when transmitting HARQ ACK). Then, when performing the wake-up skip, the UE 100 executes nothing on the timer, and when the count value reaches the timer value (restriction information) (or the count value exceeds the timer value, or the timer value expires), the UE 100 wakes up instead of skipping the wake-up in the next on-duration regardless of the inference result from the inference model.

Also in the case of the “timer method”, the UE 100 may cause the timer to start counting with reference to the on-duration (reference point) used as a start point (or reset the counter or set the counter to 0 (or set the timer value)). In this case, the UE 100 executes nothing on the timer in the next on-duration, and when the count value reaches the timer value (restriction information) (or the count value exceeds the timer value, or the timer value expires), the UE 100 wakes up instead of skipping the wake-up in the corresponding on-duration (or the next on-duration).

Third, in the case of the “wake-up period”, for example, the operation of the wake-up skip is restricted as follows. In other words, as described above, the UE 100 wakes up instead of performing the wake-up skip at the boundary (Boundary) of the “wake-up period” (or any on-duration) regardless of the inference result from the inference model, and repeats this for each “wake-up period” (see FIGS. 23A and 23B).

In step S604, the gNB 200 transmits the DL data at the timing of wake-up. In step S605, the wake-up skip operation is restricted, and the UE 100 performs the wake-up operation at the corresponding timing, and receives the DL data.

Thus, in the second operation example according to the first embodiment, the UE 100 may perform (or may be permitted to perform) the wake-up skip operation at a certain timing, and performs the same operation as the existing DRX operation at the other timings (such as when the timing expires or when the UE 100 must wake up during the wake-up period).

### Second Embodiment

A second embodiment will be described. In the second embodiment, differences from the first embodiment will mainly be described.

In the example described in the first embodiment, the UE 100 performs model inference. In an example described in the second embodiment, the gNB 200 performs model inference. In other words, the example of a “gNB-side one-sided model” will be described in which gNB 200 includes an AI/ML model.

As in the first embodiment, an object of the second embodiment is to enable DRX to be appropriately performed by using the AI/ML model. Another object of the second embodiment may be to correctly transmit an inference result from the gNB 200 to the UE 100 because the gNB 200 performs inference.

Thus, in the second embodiment, first, the base station (for example, the gNB 200) uses the AI/ML model to infer whether downlink data traffic is to occur in the next DRX on-duration. Second, the base station transmits, to the user equipment (for example, the UE 100), a first dynamic DRX indication indicating either wake up in the next DRX on-duration or sleep in the next DRX on-duration based on the inference result for occurrence or non-occurrence of the data traffic.

Thus, for example, the UE 100 can wake up or sleep in the next on-duration in accordance with the first dynamic DRX indication received from the gNB 200, and can therefore perform a DRX operation reflecting the inference result from the AI/ML model in the gNB 200. Therefore, also in the second embodiment, DRX can be appropriately performed by using the AI/ML model. In the second embodiment, since the gNB 200 generates the first dynamic DRX indication based on the inference result from the gNB 200 itself and transmits the first dynamic DRX indication to the UE 100, the inference result from the gNB 200 can be correctly carried to the UE 100.

Note that in the second embodiment, the “wake-up skip” may be described as “sleep”. The UE 100 continues the sleep state by skipping the wake-up operation. Thus, the “wake-up skip” and the “sleep” may not be distinguished from each other for use.

### (2.1) First Operation Example According to Second Embodiment

The first operation example according to the second embodiment will be described.

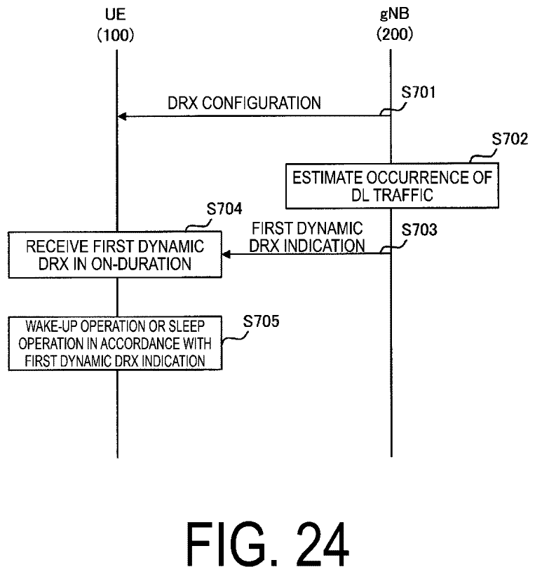

FIG. 24 is a diagram illustrating a first operation example according to the second embodiment.

As illustrated in FIG. 24, in step S701, the gNB 200 provides the DRX configuration for the UE 100. To be specific, the gNB 200 performs the configuration by transmitting an RRC message including the DRX configuration (for example, RRC reconfiguration (RRCReconfiguration) message or the like). The DRX configuration may include information indicating whether to receive the first dynamic DRX indication. The DRX configuration may include a value indicating a Radio Network Temporary Identifier (DRX-RNTI). The DRX-RNTI is used to decode (or descramble) the PDCCH carrying the DCI in the UE 100 when the first dynamic DRX indication is transmitted by the DCI (e.g. new DCI). Thus, when transmitting the first dynamic DRX indication using the DCI, the gNB 200 uses the DRX-RNTI to encode (or scramble) the PDCCH carrying the DCI.

In step S702, gNB 200 uses the inference model to infer occurrence or non-occurrence of DL data traffic in the next on-duration. The input (inference data) to and the output (inference result data) from the inference model are the same as those in the first embodiment. Based on the inference result, the gNB 200 decides whether the UE 100 wakes up or sleeps in the next on-duration (wake-up decision). In response to the wake-up decision, the gNB 200 generates a first dynamic DRX indication indicating either the wake-up of the UE 100 in the next on-duration or the sleep of the UE 100 in the next on-duration. To be specific, the gNB 200 generates the first dynamic DRX indication indicating the wake-up of the UE 100 in the next DRX on-duration when the inference model infers occurrence of DL data traffic, and indicating the sleep of the UE 100 in the next DRX on-duration when the inference model infers non-occurrence of DL data traffic.

In step S703, the gNB 200 transmits the first dynamic DRX indication to the UE 100 during the on-duration of DRX. The gNB 200 may transmit the first dynamic DRX indication to the UE 100 by utilizing the DCI (or new DCI), or may transmit the first dynamic DRX indication to the UE 100 by utilizing the MAC CE. Alternatively, the gNB 200 may transmit the first dynamic DRX indication to the UE 100 by using the RRC message (for example, RRC reconfiguration message).

In step S704, the UE 100 receives the first dynamic DRX indication in the on-duration. Here, for example, the first dynamic DRX indication will be described as including an indication to sleep in the next on-duration. The first dynamic DRX indication may include an indication to wake up in the next on-duration.

In step S705, the UE 100 performs the wake-up operation or the sleep operation in the next on-duration in accordance with the first dynamic DRX indication. Note that when not receiving the first dynamic DRX indication, the UE 100 performs the wake-up operation in the next on-duration, as is the case with the existing DRX operation.

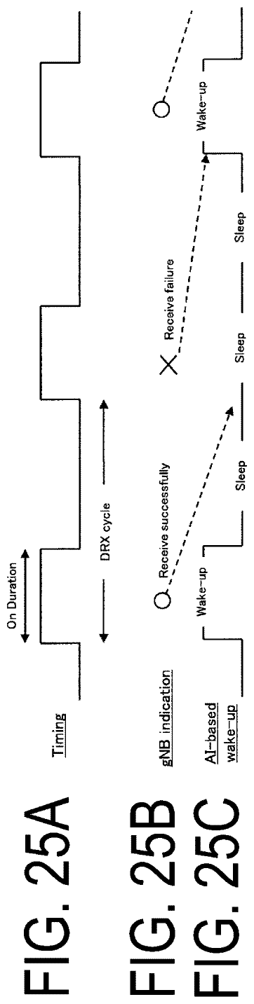

FIGS. 25A to 25C are diagrams illustrating timing examples according to the second embodiment. As illustrated in FIGS. 25A to 25C, when receiving the first dynamic DRX indication indicating the sleep in the next on-duration, the UE 100 performs the sleep operation in the next on-duration, and when not receiving the first dynamic DRX indication, the UE 100 performs the wake-up operation in the next on-duration as is the case with the existing DRX operation.

### (2.2) Second Operation Example According to Second Embodiment

A second operation example according to the second embodiment will be described. The second operation example according to the second embodiment will be described with differences from the first operation example according to the second embodiment focused on.

In the first operation example according to the second embodiment described above, the first dynamic DRX indication is used to indicate the operation for the next on-duration, but the present invention is not limited to this. For example, the gNB 200 may indicate the UE 100 not only to perform the sleep operation in the next on-duration but also to continuously perform the sleep operation during a plurality of on-durations including the next on-duration.

To be more specific, the first dynamic DRX indication includes an indication indicating that the user equipment (for example, the UE 100) is to sleep in a plurality of DRX on-durations including the next DRX on-duration (or on-duration). Thus, the UE 100 can not only sleep in the next on-duration but also continuously sleep during the subsequent on-durations, in accordance with the first dynamic DRX indication.

The second operation example according to the second embodiment provides three cases of counting a plurality of on-durations: (2.2.1) the UE 100 uses a counter, (2.2.2) the UE 100 uses a timer, (2.2.3) the UE 100 uses a control period (DRX Control Period) method. The cases will be described in order.

### (2.2.1) Counter Method

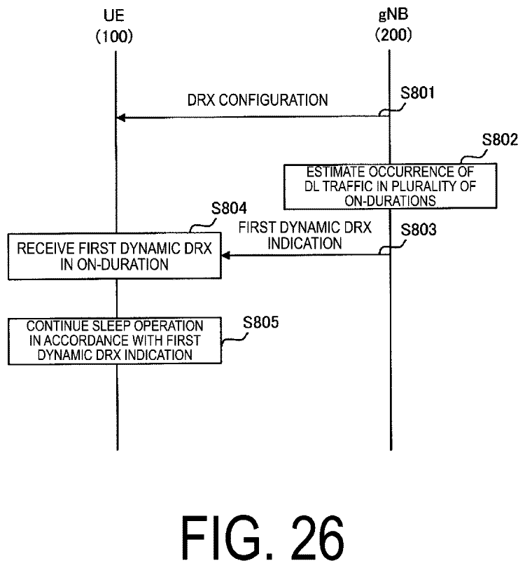

FIG. 26 is a diagram illustrating the second operation example according to the second embodiment.

As illustrated in FIG. 26, in step S801, the gNB 200 provides the DRX configuration for the UE 100.

In step S802, the gNB 200 uses the inference model to infer occurrence or non-occurrence of DL data traffic in the plurality of on-durations. The inference data (input) in the inference model may indicate whether DL data traffic occurred in a plurality of past on-durations including the current on-duration. The inference result data (output) in the inference model indicates whether DL data traffic is to occur in a plurality of on-durations in the future including the next on-duration. The gNB 200 makes the wake-up decision (decision of whether to sleep or wake up) for a plurality of on-durations based on the inference result. Then, based on the decision result, the gNB 200 generates a first dynamic DRX indication indicating the sleep of the UE 100 in a plurality of on-durations including the next on-duration. The first dynamic DRX indication may include the number of consecutive on-durations during which the UE 100 sleeps. The first dynamic DRX indication may include an indication to perform the sleep operation. The first dynamic DRX indication may imply the indication for the sleep operation by including the number of consecutive on-durations.

In step S803, the gNB 200 transmits the first dynamic DRX indication.

In step S804, the UE 100 receives the first dynamic DRX indication in the on-duration.

In step S805, the UE 100 continues to perform the sleep operation in accordance with the first dynamic DRX indication. At this time, the UE 100 counts the number of on-durations using a counter, and executes the sleep operation until the number of consecutive on-durations included in the first dynamic DRX indication is reached. Then, when the number of consecutive on-durations included in the first dynamic DRX indication is reached (or exceeded), the UE 100 ends (or resets) counting by the counter.

### (2.2.2) Timer Method

Also in the case of the timer method, the operation example illustrated in FIG. 26 is used. In this case, the DRX configuration (step S801) may include configuration information for a timer value indicating a period during which the sleep is continued. For example, the configuration information may include a start timing, a start offset, or a count unit (slot unit or the like) for the timer value.

The first dynamic DRX indication (step S803) may include the timer value. The timer value may be represented by a time inferred by the inference model and indicating a plurality of on-durations during which no DL data traffic occurs. The inclusion of the timer value in the first dynamic DRX indication may imply an indication for the sleep operation.

The UE 100 starts the timer in response to receiving the first dynamic DRX (step S804). During a timer operation, the UE 100 executes the sleep operation (step S805). The UE 100 performs the existing DRX operation when the count value of the timer reaches the timer value or the count value exceeds the timer value (i.e., when the timer value expires). In other words, the UE 100 wakes up every DRX cycle.

### (2.2.3) Control Period Method

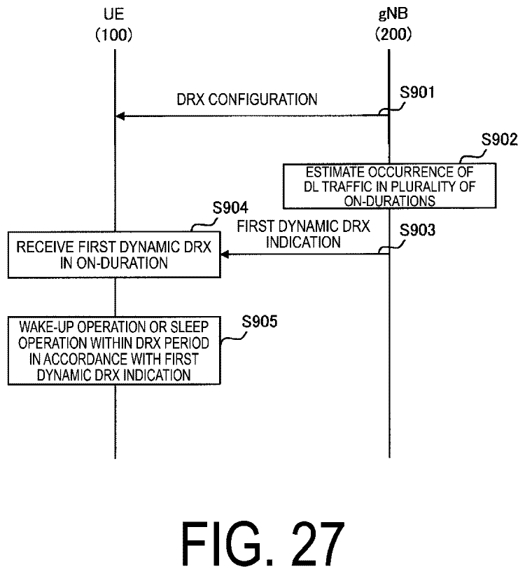

FIG. 27 is a diagram illustrating an operation example of the control period method in the second operation example according to the second embodiment. The control period represents one of the period in which the UE 100 is caused to continuously perform the wake-up operation or the period in which the UE 100 is caused to continuously perform the sleep operation.

As illustrated in FIG. 27, in step S901, the gNB 200 provides the DRX configuration for the UE 100. The DRX configuration includes configuration information related to the control period. The configuration information includes, for example, (the length of) the control period, or a start point, a start offset, or the like of the control period.

In step S902, the gNB 200 uses the inference model to infer occurrence or non-occurrence of DL data traffic in a plurality of on-durations including the next on-duration, and makes the wake-up decision based on the inference result. Here, the description assumes that the inference model infers that no DL data traffic is to occur in the plurality of on-durations. Then, the gNB 200 makes the wake-up decision based on the inference result, and determines to sleep in the plurality of on-durations. The gNB 200 defines the plurality of on-durations corresponding to sleep targets as a control period, and generates a first dynamic DRX indication including the control period. The first dynamic DRX indication may include an indication to perform a sleep operation. The first dynamic DRX indication may imply an indication for the sleep operation by including the control period.

In step S903, the gNB 200 transmits the first dynamic DRX indication to the UE 100 in the on-duration.

In step S904, the UE 100 receives the first dynamic DRX indication in the on-duration. The UE 100 confirms the control period and confirms that the UE 100 continues to sleep in the control period.

In step S905, the UE 100 continues to sleep in the control period in accordance with the first dynamic DRX indication.

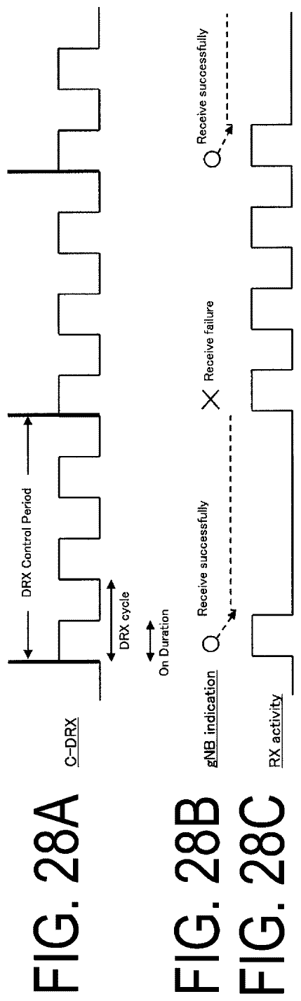

FIGS. 28A to 28C are diagrams illustrating timing examples according to the second embodiment. In the example illustrated in FIGS. 28A to 28C, the control period includes three DRX cycles, and the UE 100 performs the sleep operation during this period. As illustrated in FIGS. 28A to 28C, when not receiving the first dynamic DRX indication including the control period, the UE 100 performs the existing DRX operation.

Note that in the example of the control period method described above, the UE 100 performs the sleep operation in the control period but that the UE 100 may perform the wake-up operation in the control period. In this case, the first dynamic DRX indication (step S903) may include the length of the control period and an indication to perform the wake-up operation. The UE 100 continues to perform the wake-up operation in the control period according to the first dynamic DRX indication (step S905).

As described above, the first dynamic DRX indication includes the indication to perform one of continuing the wake-up or continuing the sleep in the control period including the plurality of on-durations.

### (2.3) Third Operation Example According to Second Embodiment

A third operation example according to the second embodiment will be described. The third operation example according to the second embodiment will be described with differences from the first and second operation examples according to the second embodiment focused on.

In the first operation example according to the second embodiment (and the second operation example according to the second embodiment), the control of the DRX operation of the UE 100 in the on-duration has been described. In the third operation example according to the second embodiment, control of the DRX operation of the UE 100 within the DRX cycle will be described.

To be more specific, first, the base station (e.g., the gNB 200) uses the AI/ML model to infer occurrence or non-occurrence of DL data traffic within the DRX cycle. Second, the base station transmits, to the user equipment (e.g., the UE 100), a second dynamic DRX indication indicating the wake-up and/or sleep within the DRX cycle based on the inference result for occurrence or non-occurrence of DL data traffic within the DRX cycle.

As described above, the gNB 200 generates the second dynamic DRX indication indicating the wake-up and/or the sleep within the DRX cycle based on the inference result from the inference model, and transmits the second dynamic DRX indication to the UE 100. Therefore, the UE 100 can perform the DRX operation in accordance with the inference result from the gNB 200 by performing the wake-up operation or the sleep operation in accordance with the second dynamic DRX indication. Thus, also in the third operation example according to the second embodiment, DRX can be appropriately performed by using the AI/ML model. Since the DRX operation within the DRX cycle is controlled, the third operation example enables the gNB 200 to transmit DL data within the DRX cycle to realize lower latency for the DL data as compared with the case where the DL data is transmitted only in the on-duration.

Note that the DRX cycle may be, for example, a long DRX cycle. The DRX cycle may be a newly defined DRX cycle. The DRX cycle is, for example, one DRX cycle and refers to a period from the start point of the on-duration to the start point of the next on-duration.

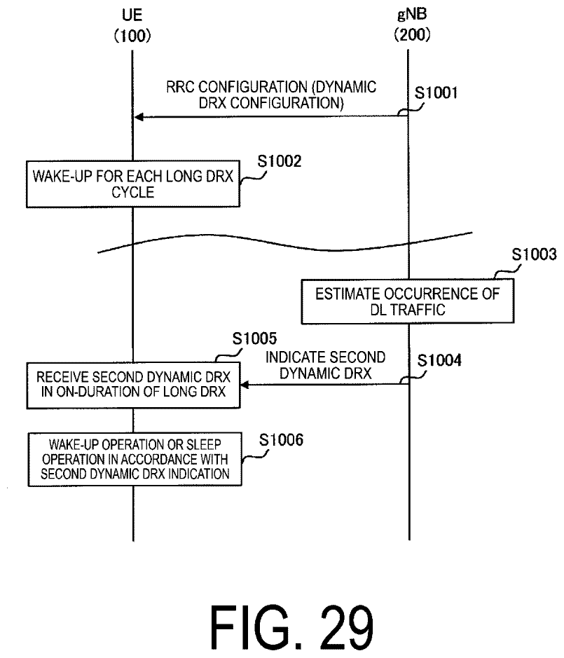

FIG. 29 is a diagram illustrating the third operation example according to the second embodiment.

As illustrated in FIG. 29, in step S1001, the gNB 200 provides the DRX configuration for the UE 100. The DRX configuration includes a long DRX configuration. The long DRX configuration includes an “on-duration” (“drx-onDurationTimer”), a “DRX cycle” (“drx-LongCycleStartOffset”), and the like. The long DRX configuration may be the existing DRX configuration. The DRX configuration includes a dynamic DRX configuration. The dynamic DRX configuration is also, for example, a DRX configuration for causing the UE 100 to perform an operation within the DRX cycle in accordance with the second dynamic DRX indication.

First, the dynamic DRX configuration includes a DRX control unit period. The DRX control unit period represents a unit time of DRX control (for example, an ON pattern or an OFF pattern) within the DRX cycle. The DRX control unit period may be expressed in units of slots. Alternatively, the DRX control unit period may be represented by a division result obtained by dividing the long DRX cycle. For example, when the long DRX cycle is 2.56 seconds and a division configuration is 4, the DRX control unit period is 0.64 seconds. The gNB 200 can indicate the wake-up or sleep for each of a plurality of DRX control unit periods included in the DRX cycle. The DRX control unit period may be represented as a dynamic DRX cycle.

Second, the dynamic DRX configuration includes an “On-duration timer” indicating the length of the on-duration within the DRX cycle. When the “On-duration timer” indicates the same length as that of the on-duration in the case of long DRX, another length need not be configured.

Third, the dynamic DRX configuration includes a DRX-RNTI. When the second dynamic DRX indication is DCI, the DRX-RNTI is used for decoding the DCI in the UE 100.

In step S1002, the UE 100 performs the wake-up operation every long DRX cycle.

In step S1003, the gNB 200 uses the inference model to infer occurrence or non-occurrence of DL data traffic within the DRX cycle. The inference data (input) of the inference model is whether DL data was generated (or received) within the last DRX cycle. The inference data may be whether DL data was generated within the past DRX cycle, or if information related to traffic characteristics has been provided from the higher layer, this information may be used as the inference data. The inference result data (output) of the inference model is whether DL data is generated in the current DRX cycle. The inference result data may be a decision result of the wake-up decision (wake-up operation or sleep operation in the dynamic DRX cycle). The gNB 200 makes the wake-up decision within the DRX cycle based on the inference result. To be more specific, based on the inference result, the gNB 200 decides whether to wake up or sleep for each DRX control unit period within the DRX cycle. The gNB 200 generates a second dynamic DRX indication including the indication for the wake-up operation or the sleep operation for each DRX control unit period in accordance with the determination result based on the wake-up decision.

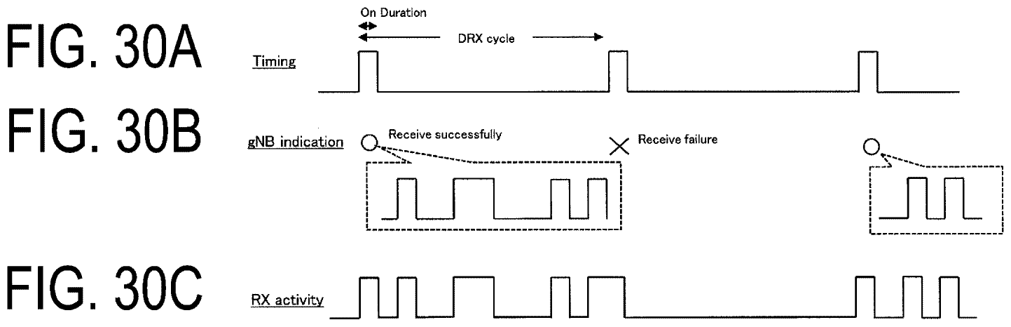

FIGS. 30A to 30C are diagrams illustrating timing examples according to the second embodiment. FIG. 30B illustrates an example of the second dynamic DRX indication. As illustrated in FIG. 30B, the second dynamic DRX indication indicates the wake-up operation or the sleep operation in DRX control units.

Referring back to FIG. 29, in step S1004, gNB 200 transmits the second dynamic DRX indication in the on-duration of the DRX cycle. The gNB 200 may transmit the second dynamic DRX indication by using the MAC CE or DCI. Alternatively, the gNB 200 may transmit the second dynamic DRX indication using the RRC message.

First, the second dynamic DRX indication may be represented by a bitmap indicating the wake-up or sleep. The DRX control unit period may be represented by one bit. In this case, “0” may represent the sleep and “1” may represent the wake-up (the bit values may be reversed). For example, when the DRX control unit period is “2” slots and the second dynamic DRX indication is {0,1,1,0}, the following is represented. In other words, “slot #0” and “slot #1” represent the sleep, “slot #2” to “slot #5” represent the wake-up, and “slot #6” and “slot #7” represent the sleep.

Second, the second dynamic DRX indication may be information indicating the number of slots after which wake-up is performed. For example, when the second dynamic DRX indication is an indication to “wake up 4 slots later”, the wake-up operation is performed 4 slots later using the start point (or end point) of the on-duration as a starting point. On the contrary, the second dynamic DRX indication may be information indicating the number of slots after which the sleep is performed.

In step S1005, the UE 100 receives the second dynamic DRX indication in the on-duration of the DRX cycle.

In step S1006, the UE 100 performs one of the wake-up operation or the sleep operation for each DRX control unit period within the DRX cycle in accordance with the second dynamic DRX indication. FIG. 30C illustrates an example of operation of the UE 100 performed upon receiving the second dynamic DRX indication.

Note that when not receiving the second dynamic DRX indication, the UE 100 performs the wake-up operation for each on-duration as is the case with the existing DRX operation.

### Third Embodiment

A third embodiment will be described. The third embodiment will be described with differences from the first embodiment and the second embodiment focused on.

In the first embodiment, the example in which the UE 100 performs inference (“UE-side one-sided model”) has been described. In the second embodiment, the example in which the gNB 200 performs inference (“gNB-side one-sided model”) has been described. In the third embodiment, an example in which both the UE 100 and the gNB 200 perform inference will be described.

When both the UE 100 and the gNB 200 perform the inference, how to perform DRX may become a problem when the inference result from the UE 100 differs from the inference result from the gNB 200. Thus, as is the case with the first embodiment, an object of the third embodiment is to enable DRX to be appropriately executed by using the AI/ML model.

### (3.1) First Operation Example According to Third Embodiment

A first operation example according to the third embodiment will be described.

In the first operation example according to the third embodiment, when the inference result from the gNB 200 agrees with the inference result from the UE 100, the UE 100 performs the wake-up operation.

To be more specific, first, the base station (for example, the gNB 200) uses the AI/ML model to infer occurrence or non-occurrence of downlink data traffic within the DRX cycle. Second, the base station transmits, to the user equipment (e.g., the UE 100), a second dynamic DRX indication indicating the wake-up and/or sleep within the DRX cycle based on the inference result for occurrence or non-occurrence of DL data traffic. Third, the user equipment uses the AI/ML model to infer occurrence or non-occurrence of the data traffic within the DRX cycle. Fourth, based on the second dynamic DRX indication and the inference result from the user equipment, the user equipment wakes up at a timing corresponding to the wake-up for both the second dynamic DRX indication and the inference result from the user equipment.

As described above, in the first operation example according to the third embodiment, the UE 100 performs the wake-up operation at the same timing indicated by both the inference result from the gNB 200 and the inference result from the UE 100. Therefore, DRX can be appropriately performed by using the AI/ML model even with a difference between the inference results, similar to the first embodiment.

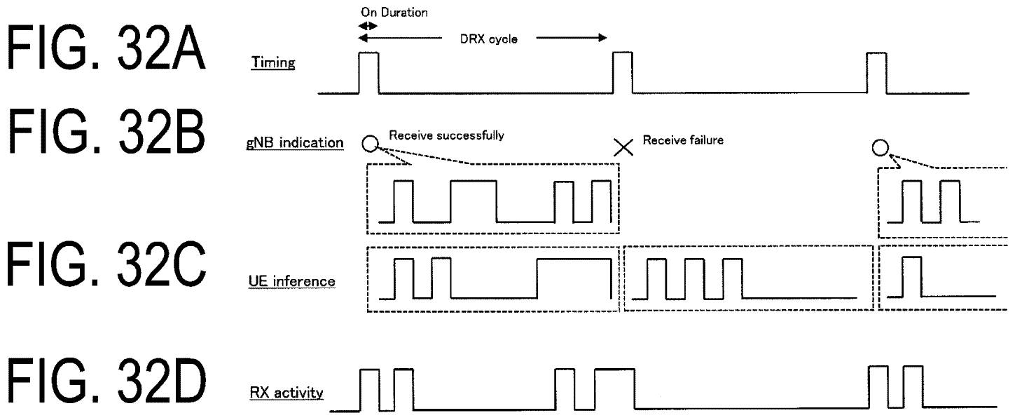

FIGS. 32A to 32D are diagrams illustrating timing examples according to the third embodiment. As illustrated in FIG. 32C, the UE 100 performs the wake-up operation at the timing corresponding to the wake-up for both the indication in the second dynamic DRX indication from the gNB 200 (FIG. 32B) and the inference result from the UE 100 (FIG. 32C).

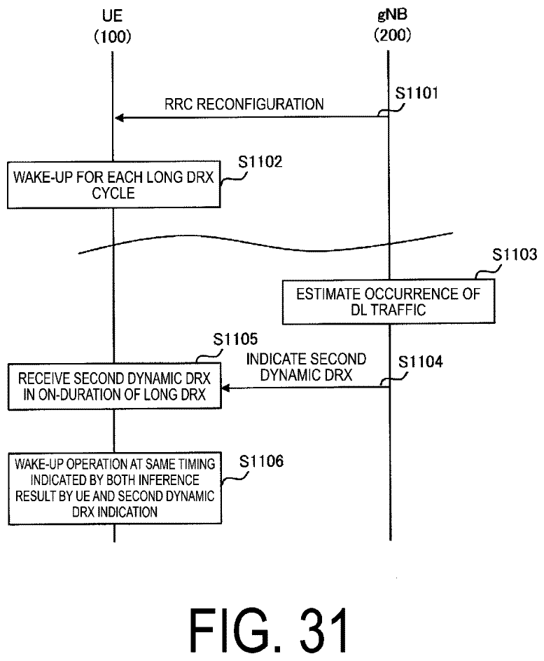

FIG. 31 is a diagram illustrating the first operation example according to the third embodiment.

As illustrated in FIG. 31, in step S1101, the gNB 200 provides the RRC configuration for the UE 100. The RRC configuration may include information indicating that the UE 100 and the gNB 200 cooperate in determining the wake-up timing. The RRC configuration may include the long DRX configuration and the dynamic DRX configuration described in the third operation example of the second embodiment.

In step S1102, the UE 100 performs the wake-up operation every long DRX cycle.

In step S1103, gNB 200 uses the inference model to infer occurrence or non-occurrence of DL data traffic. The gNB 200 makes the wake-up decision in accordance with the inference result, and generates a second dynamic DRX indication. Step S1103 is the same as that of the third operation example of the second embodiment (step S1003).

In step S1104, the gNB 200 transmits the second dynamic DRX indication to the UE 100 in the on-duration of the long DRX cycle.

In step S1105, the UE 100 receives the second dynamic DRX indication in the on-duration. The UE 100 then uses the inference model to infer occurrence or non-occurrence of the data traffic within the DRX cycle. The inference model used by UE 100 may be the same as or different from the inference model used by gNB 200. The inference data (input) and inference result data (output) of the inference model used by UE 100 are the same as those in the third operation example of the second embodiment (step S1003).

In step S1106, based on the second dynamic DRX indication and the inference result from the UE 100, the UE 100 performs the wake-up operation at the timing corresponding to the wake-up for both the second dynamic DRX indication and the inference result from the UE 100. Based on the second dynamic DRX indication and the inference result from the UE 100, the UE 100 may perform the wake-up operation at the timing corresponding to the wake-up for one of the second dynamic DRX indication or the inference result from the UE 100.

### (3.1.1) Other Example 1 of First Operation Example According to Third Embodiment

In the first operation example according to the third embodiment described above, the second dynamic DRX indication is used, but the present invention is not limited to this. For example, even when the first dynamic DRX indication is used, the UE 100 may perform the wake-up operation when the inference result from the gNB 200 agrees with the inference result from the UE 100.

To be more specific, first, the base station (for example, the gNB 200) uses the AI/ML model to infer whether downlink data traffic is to occur in the next DRX on-duration. Second, the base station transmits, to the user equipment (for example, the UE 100), a first dynamic DRX indication indicating either wake up in the next DRX on-duration or sleep in the next DRX on-duration based on the inference result for occurrence or non-occurrence of the data traffic. Third, the user equipment uses the AI/ML model to infer whether DL data traffic is to occur in the next DRX on-duration. Fourth, based on the first dynamic DRX indication and the inference result from the user equipment, the user equipment wakes up at the timing corresponding to the wake-up for both the first dynamic DRX indication and the inference result from the user equipment.

In Other Example 1, the operation example illustrated in FIG. 31 may be used. In this case, the estimation of the DL data traffic (step 1103) is the same as that of the first operation example according to the second embodiment (step S702), and can be implemented by replacing the “second dynamic DRX indication” (step S1104 and step S1106) with the “first dynamic DRX indication”.

### (3.1.2) Other Example 2 of First Operation Example According to Third Embodiment

In the first operation example according to the third embodiment described above, the UE 100 performs the wake-up operation at the same timing indicated by both the inference result from the gNB 200 and the inference result from the UE 100, but the present invention is not limited to this. For example, the UE 100 may perform the sleep operation at the same timing indicated by both the inference result from the gNB 200 and the inference result from the UE 100.

For example, in the example of FIG. 32D, the UE 100 performs the sleep operation at the sleep timing indicated by the second dynamic DRX indication from the gNB 200, which is the same as the sleep timing inferred by the UE 100.

Thus, also in Other Example 2, as is the case with the first operation example according to the third embodiment, DRX can be appropriately performed by using the AI/ML model even with a difference in inference result between the UE 100 and the gNB 200.

### (3.2) Second Operation Example According to Third Embodiment

A second operation example according to the third embodiment will be described. The second operation example according to the third embodiment will be described with differences from the first operation example according to the first embodiment focused on.

In the second operation example according to the third embodiment, when receiving no indication from the gNB 200, the UE 100 performs one of the wake-up operation or the sleep operation utilizing the inference result from the UE 100. To be specific, when not receiving the second dynamic DRX indication, the user equipment (for example, the UE 100) performs one of the wake-up or the sleep based on the inference result from the user equipment.

For example, in the case of DCI, even when the gNB 200 transmits the second dynamic DRX indication to the UE 100, the UE 100 transmits no feedback information. Thus, the gNB 200 fails to know whether the UE 100 has received the second dynamic DRX indication. For example, a case is assumed in which even when the gNB 200 has transmitted the DCI, the UE 100 has failed to receive the second dynamic DRX indication due to a deteriorating radio situation or the like. In the second operation example according to the third embodiment, even when such a case is assumed, inference and decision for the UE 100 are allowed and the UE 100 is caused to perform the DRX operation based on the inference result from the UE 100 itself, thus causing DRX to be appropriately executed by using the AI/ML model.

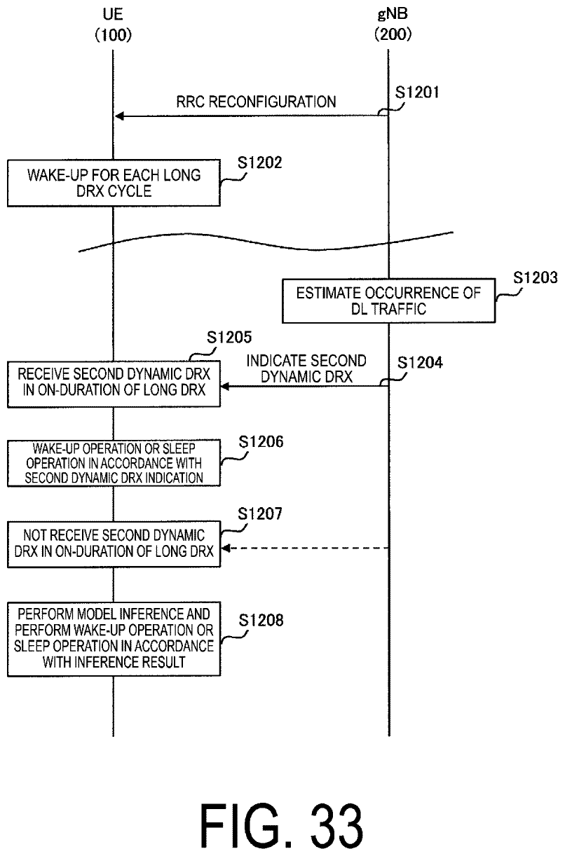

FIG. 33 is a diagram illustrating the second operation example according to the third embodiment.

As illustrated in FIG. 33, in step S1201, the gNB 200 provides the RRC configuration for the UE 100. As is the case with the first operation example according to the third embodiment, the RRC configuration may include information indicating that the wake-up timing is jointly determined, and may include the long DRX configuration and the dynamic DRX configuration.

In step S1202, the UE 100 wakes up every long DRX cycle.

In step S1203, the gNB 200 uses the inference model to infer occurrence or non-occurrence of DL data traffic. As is the case with the first operation example according to the third embodiment, the gNB 200 makes the wake-up decision based on the inference result, and generates the second dynamic DRX indication.

In step S1204, gNB 200 transmits the second dynamic DRX indication in the long DRX on-duration.

In step S1205, the UE 100 receives a second dynamic DRX indication in the on-duration. In this case, in step S1206, UE 100 performs one of the wake-up operation or the sleep operation in accordance with the second dynamic DRX indication.

In the step S1207, the UE 100 does not receive the second dynamic DRX indication in the on-duration. In this case, in step S1208, the UE 100 infers occurrence or non-occurrence of DL data traffic using the inference model, and performs one of the wake-up operation or the sleep operation in accordance with the inference result.

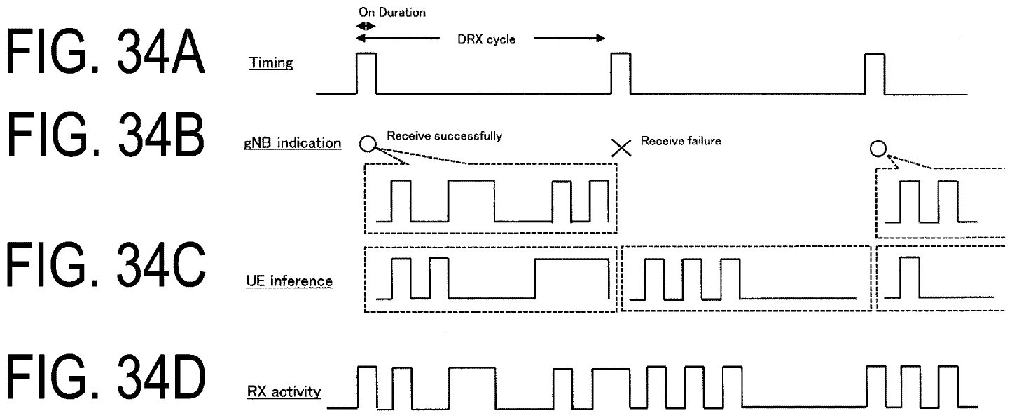

FIGS. 34A to 34D are diagrams illustrating timing examples according to the third embodiment. As illustrated in FIG. 34D, upon receiving the second dynamic DRX indication from the gNB 200, the UE 100 performs one of the wake-up operation or the sleep operation in accordance with the second dynamic DRX indication. On the other hand, when not receiving the second dynamic DRX indication, the UE 100 performs one of the wake-up operation or the sleep operation in accordance with the inference result from the UE 100 itself.

Note that the second operation example according to the third embodiment describes the operation performed by the UE 100 when not receiving the second dynamic DRX indication, but the operation is not limited to this. The second operation example can be implemented even when the UE 100 does not receive the first dynamic DRX indication instead of the second dynamic DRX indication. In this case, when not receiving the first dynamic DRX indication, the UE 100 may perform the wake-up operation and the sleep operation in the on-duration in accordance with the inference result from the UE 100 itself as is the case with the second operation example according to the third embodiment described above.

### OTHER EMBODIMENTS

In the first to third embodiments described above, the supervised learning has mainly been described. However, the present disclosure is not limited thereto. For example, the first embodiment may be applied to the unsupervised learning or the reinforcement learning.

The operation flows described above can be separately and independently implemented, and also be implemented in combination of two or more of the operation flows. For example, some steps of one operation flow may be added to another operation flow or some steps of one operation flow may be replaced with some steps of another operation flow. In each flow, all steps may not be necessarily performed, and only some of the steps may be performed.

Although the example in which the base station is an NR base station (gNB) has been described in the embodiments and examples described above, the base station may be an LTE base station (eNB) or a 6G base station. The base station may be a relay node such as an Integrated Access and Backhaul (IAB) node. The base station may be a DU of the IAB node. The UE 100 may be a Mobile Termination (MT) of the IAB node.

The term “network node” mainly means a base station, but may also mean a core network apparatus or a part (CU, DU, or RU) of the base station. The network node may include a combination of at least a part of the apparatus of the core network and at least a part of the base station.

A program (e.g., information processing program) for causing a computer to execute each process or each function according to the above-described embodiment may be provided. A program (e.g., mobile communication program) may be provided that causes the mobile communication system 1 to execute each of the processing operations or each of the functions according to the embodiments described above. The program may be recorded in a computer-readable medium. Use of the computer-readable medium enables the program to be installed on a computer. Here, the computer-readable medium on which the program is recorded may be a non-transitory recording medium. The non-transitory recording medium is not particularly limited, and may be, for example, a recording medium such as a CD-ROM or a DVD-ROM. Such a recording medium may be a memory included in the UE 100 and the gNB 200. Circuits for executing processing performed by the UE 100 or the gNB 200 may be integrated, and at least a part of the UE 100 and the gNB 200 may be implemented as a semiconductor integrated circuit (chipset, System on a chip (SoC)).

The functions realized by the UE 100 or the gNB 200 (network node) may be implemented in circuitry or processing circuitry including general-purpose processors, special-purpose processors, integrated circuits, Application Specific Integrated Circuits (ASICs), Central Processing Units (CPUs), conventional circuits, and/or combinations thereof which are programmed to perform the described functionality. The processor may include transistors or any other circuits and may be considered to be circuitry or processing circuitry. The processor may be a programmed processor that executes a program stored in the memory. As used herein, circuitry, a unit, means is hardware programmed to achieve, or hardware executing, the described functionality. The hardware may be any hardware disclosed herein or any hardware programmed to achieve or known to execute the described functionality. When the hardware is a processor that is considered to be a type of circuitry, the circuitry, means, or unit is a combination of hardware and software used to configure the hardware and/or processor.

The phrases “based on” and “depending on/in response to” used in the present disclosure do not mean “based only on” and “only depending on/in response to” unless specifically stated otherwise. The phrase “based on” means both “based only on” and “based at least in part on.” The phrase “depending on” means both “only depending on” and “at least partially depending on.” The terms “include,” “comprise” and variations thereof do not mean “include only items stated” but instead mean “may include only items stated” or “may include not only the items stated but also other items.” The term “or” used in the present disclosure is not intended to be “exclusive or.” Any references to elements using designations such as “first” and “second” as used in the present disclosure do not generally limit the quantity or order of those elements. These designations may be used herein as a convenient method of distinguishing between two or more elements. Thus, a reference to first and second elements does not mean that only two elements may be employed there or that the first element needs to precede the second element in some manner. For example, when the English articles such as “a,” “an,” and “the” are added in the present disclosure through translation, these articles include the plural unless clearly indicated otherwise in context.

Embodiments have been described above in detail with reference to the drawings, but specific configurations are not limited to those described above, and various design variation can be made without departing from the gist of the present disclosure. It is also possible to combine each embodiment, each operation example, each process, and the like without contradicting.

### Supplements

### Supplementary Note 1

A communication control method in a mobile communication system, the communication control method including the steps of:
inferring, by a user equipment, occurrence or non-occurrence of data traffic in a downlink in a next DRX on-duration by using an AI/ML model; and
performing, by the user equipment, one of wake-up in the next DRX on-duration or skipping of the wake-up in the next DRX on-duration, based on an inference result for occurrence or non-occurrence of the data traffic.

### Supplementary Note 2

The communication control method according to Supplementary Note 1, wherein
the performing one of the wake-up or the skipping of the wake-up includes performing, by the user equipment, the wake-up in the next DRX on-duration when the user equipment infers occurrence of the data traffic, and the skipping of the wake-up in the next DRX on-duration when the user equipment infers non-occurrence of the data traffic.

### Supplementary Note 3

The communication control method according to Supplementary Note 1 or 2, further including: configuring, by a network node, the user equipment with permission to skip the wake-up.

### Supplementary Note 4

The communication control method according to any one of Supplementary Notes 1 to 3, further including:
adjusting, by the user equipment, a duration of the wake-up in accordance with an occurrence probability of the data traffic.

### Supplementary Note 5

The communication control method according to any one of Supplementary Notes 1 to 4, wherein
the inferring includes inferring, by the user equipment, occurrence or non-occurrence of the data traffic based on inference results from a plurality of the AI/ML models.

### Supplementary Note 6

The communication control method according to any one of Supplementary Notes 1 to 5, further including:
configuring, by the network node, the user equipment with an operation restriction on the skipping of the wake-up.

### Supplementary Note 7

The communication control method according to any one of Supplementary Notes 1 to 6, wherein
the operation restriction is any one of an upper limit number of consecutive executions of the skipping, an upper limit time of the consecutive executions of the skipping, or a repetition period during which the wake-up needs to be performed.

### Supplementary Note 8

A communication control method in a mobile communication system, the communication control method including the steps of:
inferring, by a network node, occurrence or non-occurrence of data traffic in a downlink in a next DRX on-duration by using an AI/ML model;
transmitting, by the network node to a user equipment, a first dynamic DRX indication indicating one of wake-up in the next DRX on-duration or sleep in the next DRX on-duration, based on an inference result for occurrence or non-occurrence of the data traffic;
inferring, by the user equipment, occurrence or non-occurrence of the data traffic in the next DRX on-duration by using the AI/ML model; and
performing, by the user equipment, the wake-up at a timing corresponding to wake-up indicated by both the first dynamic DRX indication and the inference result from the user equipment, based on the first dynamic DRX indication and the inference result from the user equipment.

### Supplementary Note 9

The communication control method according to Supplementary Note 8, wherein
the performing of the wake-up includes performing, by the user equipment, one of the wake-up or the sleep in accordance with the inference result from the user equipment, when the user equipment has not received the first dynamic DRX indication.

### REFERENCE SIGNS

1: Mobile communication system
20: 5GC (CN)
100: UE
110: Receiver
120: Transmitter
130: Controller
200: gNB
210: Transmitter
220: Receiver
230: Controller
250: Backhaul communicator
A1: Data collector
A2: Model trainer
A3: Model inferrer
A4: Data processor
TE: Transmission entity
RE: Reception entity

1. A communication control method in a mobile communication system, the communication control method comprising the steps of:
inferring, by a user equipment, occurrence or non-occurrence of data traffic in a downlink in a next DRX on-duration by using an Artificial Intelligence (AI)/Machine Learning (ML) model; and
performing, by the user equipment, one of wake-up in the next DRX on-duration or skipping of the wake-up in the next DRX on-duration, based on an inference result for occurrence or non-occurrence of the data traffic.

2. The communication control method according to claim 1, wherein
the performing one of the wake-up or the skipping of the wake-up comprises performing, by the user equipment, the wake-up in the next DRX on-duration when the user equipment infers occurrence of the data traffic, and the skipping of the wake-up in the next DRX on-duration when the user equipment infers non-occurrence of the data traffic.

3. The communication control method according to claim 1, further comprising:
configuring, by a network node, the user equipment with permission to skip the wake-up.

4. The communication control method according to claim 1, further comprising:
adjusting, by the user equipment, a duration of the wake-up in accordance with an occurrence probability of the data traffic.

5. The communication control method according to claim 1, wherein
the inferring comprises inferring, by the user equipment, occurrence or non-occurrence of the data traffic based on inference results from a plurality of the AI/ML models.

6. The communication control method according to claim 1, further comprising:
configuring, by the network node, the user equipment with an operation restriction on the skipping of the wake-up.

7. The communication control method according to claim 6, wherein
the operation restriction is any one of an upper limit number of consecutive executions of the skipping, an upper limit time of the consecutive executions of the skipping, or a repetition period during which the wake-up needs to be performed.

8. A communication control method in a mobile communication system, the communication control method comprising the steps of:
inferring, by a network node, occurrence or non-occurrence of data traffic in a downlink in a next DRX on-duration by using an AI/ML model;
transmitting, by the network node to a user equipment, a first dynamic DRX indication indicating one of wake-up in the next DRX on-duration or sleep in the next DRX on-duration, based on an inference result for occurrence or non-occurrence of the data traffic;
inferring, by the user equipment, occurrence or non-occurrence of the data traffic in the next DRX on-duration by using an AI/ML model; and
performing, by the user equipment, the wake-up at a timing corresponding to wake-up indicated by both the first dynamic DRX indication and the inference result from the user equipment, based on the first dynamic DRX indication and the inference result from the user equipment.

9. The communication control method according to claim 8, wherein
the performing of the wake-up comprises performing, by the user equipment, one of the wake-up or the sleep in accordance with the inference result from the user equipment, when the user equipment has not received the first dynamic DRX indication.

10. A user equipment in a mobile communication system, the user equipment comprising:
a controller configured to:
infer, by using an Artificial Intelligence (AI)/Machine Learning (ML) model, occurrence or non-occurrence of data traffic in a downlink in a next DRX on-duration; and
perform, based on an inference result for the occurrence or non-occurrence of the data traffic, one of wake-up in the next DRX on-duration or skipping of the wake-up in the next DRX on-duration.
